(19) United States
(12) Patent Application Publication
(10) Pub. No.: US 2021/0049091 A1
(43) Pub. Date: Feb. 18, 2021

(54) SOFTWARE VISUALIZATION APPARATUS, SOFTWARE VISUALIZATION METHOD, AND COMPUTER READABLE MEDIUM

(71) Applicant: Mitsubishi Electric Corporation, Chiyoda-ku, Tokyo (JP)

(72) Inventors: Yuki HIKAWA, Tokyo (JP); Taishi AZUMA, Tokyo (JP); Toshihiro KOBAYASHI, Tokyo (JP); Hironori KURATA, Tokyo (JP); Ryota OKUMURA, Tokyo (JP)

(73) Assignee: Mitsubishi Electric Corporation, Chiyoda-ku, Tokyo (JP)

(21) Appl. No.: 16/966,218

(22) PCT Filed: Aug. 24, 2018
(86) PCT No.: PCT/JP2018/031407

§ 371 Date: Jul. 30, 2020

(30) Foreign Application Priority Data
Feb. 15, 2018 (JP) 2018-024808

(51) Int. Cl. G06F 11/36; G06F 11/32

(52) U.S. Cl. CPC G06F 11/3664; G06F 11/323; G06F 11/3688; G06F 11/3636

(57) ABSTRACT

A reception unit receives an execution history file of a target program and a software structure file of the target program. An association unit associates each piece of execution element information of the execution history file and each piece of component information of the software structure file with each other, thereby generating an association file. A determination unit determines each execution element and a parent element of each execution element as important elements by referring to the software structure file based on the association file, thereby generating an important element file indicating each important element. A visualization unit generates a visualization diagram indicating the structure of the target program in a state where each important element has been emphasized, based on the important element file and the software structure file.

### TECHNICAL FIELD

The present invention relates to visualization of the structure of software.

### BACKGROUND ART

As a method of understanding an operation of a program and analyzing a fault of the program, there is a method of illustrating transition information of the program or narrowing down and displaying a portion desired to be noticed, based on execution history of the program.

Patent Literature 1 discloses the following method.

A dependency between respective program elements and so on are analyzed in advance, and trace information on the check range of a program operation is successively extracted. Then, the program operation is virtually reproduced by tracing at a source code level. On that occasion of the reproduction, the trace information is al so displayed.

The trace information is categorized and information concealment is performed, based on program structure information, and detailing or outlining limited to an information portion to be focused on is performed, thereby implementing adjustment of an information amount.

A flow of sequential control and a flow of data in the program are visualized as an event trace chart and is displayed in conjunction with a source code.

### CITATION LIST

### Patent Literature

Patent Literature 1: JP 2002-108649A

### SUMMARY OF INVENTION

### Technical Problem

In the conventional method, only the portion that has been executed can be focused. Therefore, an important function that has not been executed may be overlooked or may be erroneously understood.

Further, when there are a lot of portions that have been executed, the range to be narrowed down may increase. Therefore, it cannot be known where should be selectively checked.

Further, an element that is infrequently executed but is important may be overlooked.

An object of the present invention is to enable prevention of overlooking of an important element.

### Solution to Problem

A software visualization apparatus of the present invention may include:

a reception unit to receive an execution history file including execution element information for each execution element that is a component which has been executed among a plurality of components that are included in a target program and a software structure file including component information for each component as information indicating a structure of the target program;

an association unit to associate each piece of execution element information of the execution history file and each piece of component information of the software structure file with each other, thereby generating an association file;

a determination unit to determine each execution element and a parent element of each execution element as important elements by referring to the software structure file based on the association file and generate an important element file indicating each important element; and

a visualization unit to generate a visualization diagram indicating the structure of the target program in a state where each important element has been emphasized, based on the important element file and the software structure file.

### Advantageous Effects of Invention

According to the present invention, it becomes possible to prevent overlooking of an important element.

### BRIEF DESCRIPTION OF DRAWINGS

FIG. 1 is a configuration diagram of a software visualization apparatus 100 in a first embodiment.

FIG. 2 is a flowchart of a software visualization method in the first embodiment.

FIG. 3 is a table illustrating an execution history file 201 in the first embodiment.

FIG. 4 is a table illustrating a software structure file 202 in the first embodiment.

FIG. 5 is a flowchart of an association process (S110) in the first embodiment.

FIG. 6 is a table illustrating an association file 203 in the first embodiment.

FIG. 7 is a table illustrating an important element file 204 in the first embodiment.

FIG. 8 is a flowchart of a determination process (S120) in the first embodiment.

FIG. 9 is a diagram illustrating a call graph 210 in the first embodiment.

FIG. 10 is a diagram illustrating a flowchart 220 in the first embodiment.

FIG. 11 is a configuration diagram of a software visualization apparatus 100 in a second embodiment.

FIG. 12 is a flowchart of a software visualization method in the second embodiment.

FIG. 13 is a table illustrating an important element file 204 in the second embodiment.

FIG. 14 is a flowchart of a determination process (S220) in the second embodiment.

FIG. 15 is a diagram illustrating a call graph 210 in the second embodiment.

FIG. 16 is a flowchart of a software visualization method in a third embodiment.

FIG. 17 is a table illustrating an important element file 204 in the third embodiment.

FIG. 18 is a flowchart of a determination process (S320) in the third embodiment.

FIG. 19 is a flowchart of an evaluation index registration process (S321) in the third embodiment.

FIG. 20 is a diagram illustrating a call graph 210 in the third embodiment.

FIG. 21 is a flowchart of a software visualization method in a fourth embodiment.

FIG. 22 is a table illustrating an important element file 204 in the fourth embodiment.

FIG. 23 is a flowchart of a determination process (S420) in the fourth embodiment.

FIG. 24 is a flowchart of an influence element registration process (S426) in the fourth embodiment.

FIG. 25 is a diagram illustrating a call graph 210 in the fourth embodiment.

FIG. 26 is a flowchart of a software visualization method in a fifth embodiment.

FIG. 27 is a table illustrating a software structure file 202 in the fifth embodiment.

FIG. 28 is a table illustrating an important element file 204 in the fifth embodiment.

FIG. 29 is a flowchart of a determination process (S520) in the fifth embodiment.

FIG. 30 is a flowchart of a changed element determination process (S527) in the fifth embodiment.

FIG. 31 is a diagram illustrating a call graph 210 in the fifth embodiment.

FIG. 32 is a flowchart of a software visualization method in a sixth embodiment.

FIG. 33 is a table illustrating an association file 203 in the sixth embodiment.

FIG. 34 is a flowchart of an association process (S610) in the sixth embodiment.

FIG. 35 is a configuration diagram of a software visualization apparatus 100 in a seventh embodiment.

FIG. 36 is a flowchart of a software visualization method in the seventh embodiment.

FIG. 37 is a table illustrating an important element file 204 in the seventh embodiment.

FIG. 38 is a flowchart of an exclusion process (S730) in the seventh embodiment.

FIG. 39 is a hardware configuration diagram of the software visualization apparatus 100 in each embodiment.

### DESCRIPTION OF EMBODIMENTS

A same reference numeral is given to the same or equivalent elements in embodiments and drawings. A description of the same or equivalent elements to which the same reference numeral has been given will be suitably omitted or simplified. Each arrow in the drawings mainly indicates a data flow or a process flow.

### First Embodiment

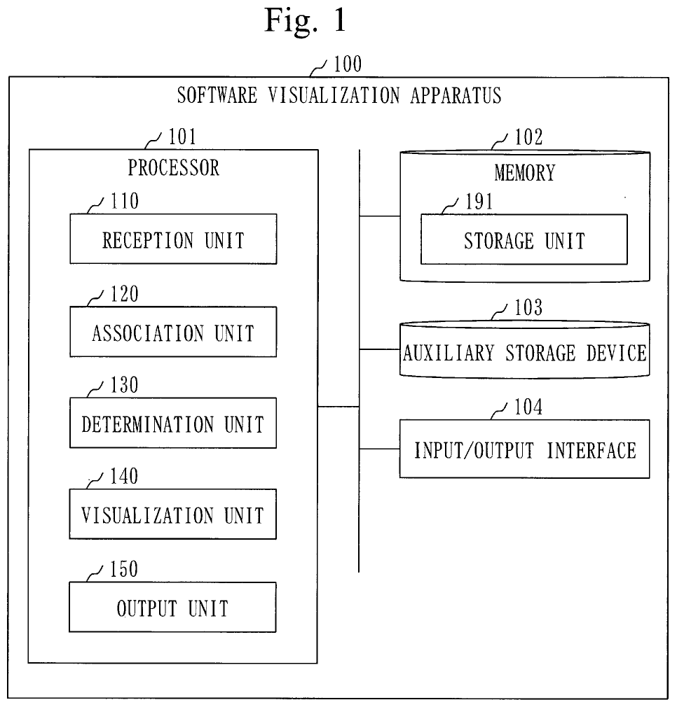

Based on FIGS. 1 to 10, a description will be given about an embodiment where each element that has been executed among elements constituting a program is visualized as an important element.

***Description of Configuration***

A configuration of a software visualization apparatus 100 will be described based on FIG. 1.

The software visualization apparatus 100 is a computer including hardware such as a processor 101, a memory 102, an auxiliary storage device 103, and an input/output interface 104. These pieces of the hardware are connected to one another via signal lines.

The processor 101 is an IC (Integrated Circuit) to perform arithmetic processing and controls the other pieces of the hardware. The processor 101 is a CPU (Central Processing Unit), a DSP (Digital Signal Processor), or a GPU (Graphics Processing Unit), for example.

The memory 102 is a non-volatile storage device. The memory 102 is referred to as a main storage device or a main memory. The memory 102 is a RAM (Random Access Memory), for example. Data stored in the memory 102 is saved in the auxiliary storage device 103 as necessary.

The auxiliary storage device 103 is a non-volatile storage device. The auxiliary storage device 103 is a ROM (Read Only Memory), an HDD (Hard Disk Drive), or a flash memory. The data stored in the auxiliary storage device 103 is loaded into the memory 102 as necessary.

The input/output interface 104 is a port to which an input device and an output device are connected. The input/output interface 104 is a USB terminal, for example, the input device is a keyboard and a mouse, for example, and the output device is a display, for example. USB is an abbreviation for Universal Serial Bus.

The software visualization apparatus 100 includes elements such as a reception unit 110, an association unit 120, a determination unit 130, a visualization unit 140, and an output unit 150. These elements are implemented by software.

A software visualization program for causing the computer to function as the reception unit 110, the association unit 120, the determination unit 130, the visualization unit 140, the output unit 150, and a storage unit 191 is stored in the auxiliary storage device 103. The software visualization program is loaded into the memory 102 and is then executed by the processor 101.

An OS (Operating System) is further stored in the auxiliary storage device 103. At least a part of the OS is loaded into the memory 102 and is then executed by the processor 101.

That is, the processor 101 executes the software visualization program while executing the OS.

Data that is obtained by executing the software visualization program is stored in a storage device such as the memory 102, the auxiliary storage device 103, or a register in the processor 101 or a cache memory in the processor 101.

The memory 102 functions as the storage unit 191. A different storage device, however, may function as the storage unit 191 in place of the memory 102 or together with the memory 102.

The software visualization apparatus 100 may include a plurality of processors that substitute the processor 101. The plurality of processors share the roles of the processor 101.

The software visualization program can be recorded (stored) in a non-volatile recording medium such as an optical disk or a flash memory in a computer-readable manner.

***Description of Operations***

Operations of the software visualization apparatus 100 correspond to a software visualization method. A procedure for the software visualization method corresponds to a procedure for the software visualization program.

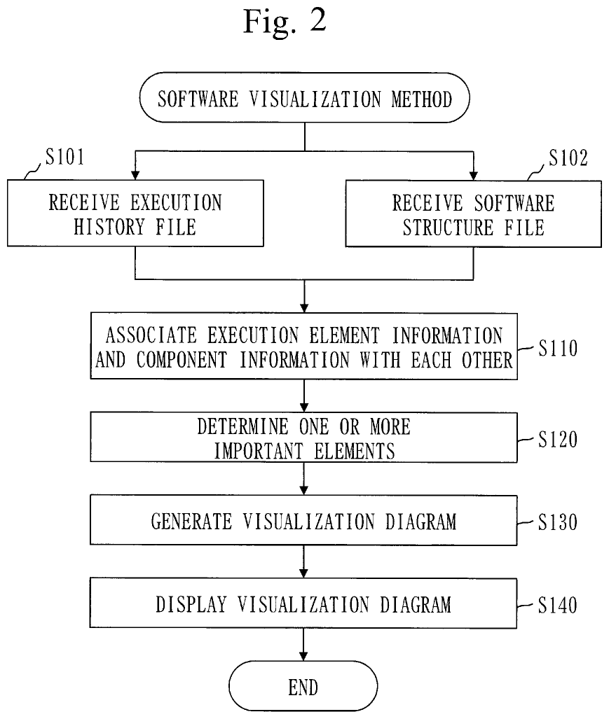

The software visualization method will be described based on FIG. 2.

In step S101, the reception unit 110 receives an execution history file 201.

Then, the reception unit 110 stores the execution history file 201 in the storage unit 191.

The execution history file 201 is obtained by executing a target program.

The target program is a program to be visualized.

The execution history file 201 includes execution element information for each execution element.

Each execution element is a component which has been executed among a plurality of components that are included in the target program.

An example of the component is one of a file, class, a function, and a statement.

An example of the execution element is one of the function and the statement.

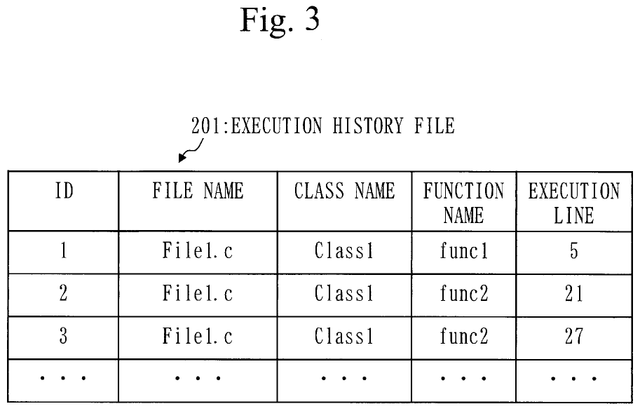

The execution history file 201 will be described based on FIG. 3.

The execution history file 201 associates an ID, a file name, a class name, a function name, and an execution line with one another.

A set of the ID, the file name, the class name, the function name, and a line number constitutes the execution element information.

The ID is an identifier for identifying the execution element information.

The function name identifies a function that has been executed.

The class name identifies a class to which the function belongs.

The file name identifies a file where the class has been described.

The execution line is a line where the function has been called and is identified by the line number.

The description will be continued from step S102 by returning to FIG. 2.

In step S102, the reception unit 110 receives a software structure file 202.

Then, the reception unit 110 stores the software structure file 202 in the storage unit 191.

The software structure file 202 is obtained by analyzing the structure of the target program.

The software structure file 202 includes component information for each component that is included in the target program.

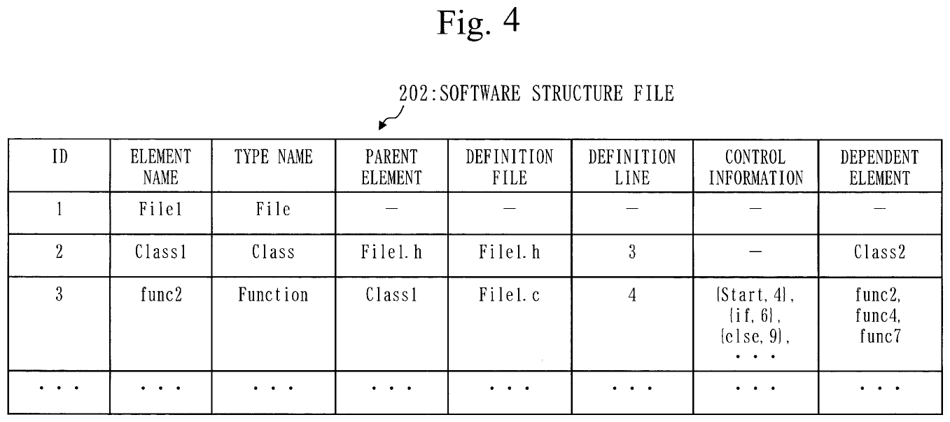

The software structure file 202 will be described based on FIG. 4.

The software structure file 202 associates an ID, an element name, a type name, a parent element, a definition file, a definition line, a control information, and a dependent element with one another.

A set of the ID, the element name, the type name, the parent element, the definition file, a line number, the control information, and the dependent element constitutes the component information.

The ID is an identifier for identifying the component information.

The element name identifies the component.

The type name identifies the type of the component.

The parent element is a higher order element of the component. The component belongs to the parent element. To take an example, a function {Func2} belongs to a class {Class1}. The class {Class1} is defined in a file {File1.h}.

The definition file is a file in which the component has been defined.

The definition line is a line in the definition file, in which the component is defined, and is identified by the line number.

The control information is information on a control structure the component includes, and indicates a control instruction and a description line. The description line is a line in which the control instruction has been described, and is identified by a line number. {X, Y} denotes a control instruction X and a description line Y. The control instruction is one of start, end, if, else, while, and switch, for example.

The dependent element is an element on which the component depends. When the component is a function, for example, the dependent element is a function for calling the component or a function that is called by the component.

A hyphen of “-” in each field denotes that there is no information.

The description will be continued from step S110 by returning to FIG. 2.

In step S110, the association unit 120 mutually associates each piece of the execution element information in the execution history file 201 and each piece of the component information in the software structure file 202.

Then, the association unit 120 generates an association file 203 in which each piece of the execution element information and each piece of the component information have mutually been associated. The association file 203 is stored in the storage unit 191.

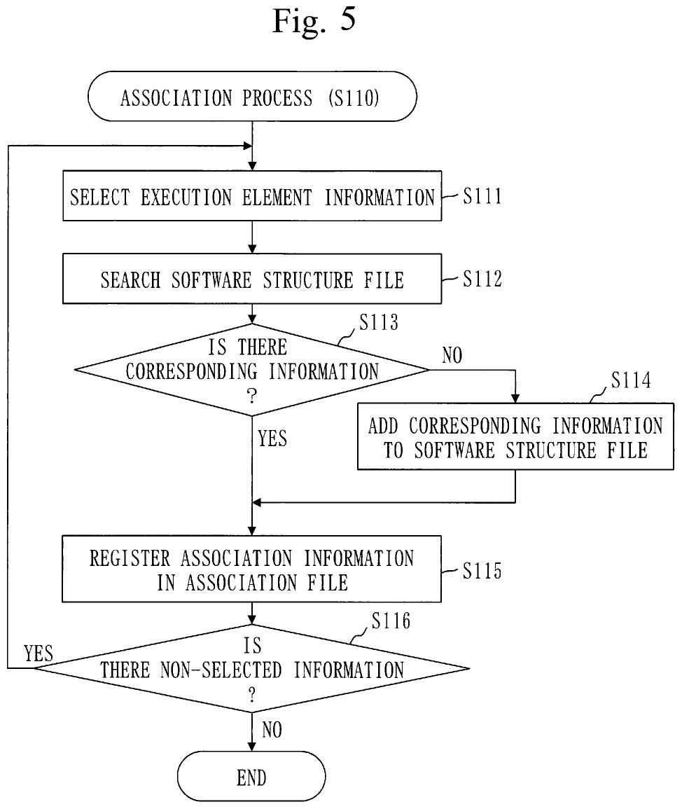

A procedure for the association process (S110) will be described based on FIG. 5.

In step S111, the association unit 120 selects, from the execution history file 201, one piece of the execution element information that has not been selected.

Steps S112 to S115 are executed for the execution element information that has been selected in step S111.

In step S112, the association unit 120 searches the software structure file 202, thereby searching the component information associated with the execution element information.

Specifically, the association unit 120 extracts, from the execution element information, the function name, and then searches, from the software structure file 202, the component information including the element name that is the same as the extracted function name.

In step S113, the association unit 120 determines whether there is the component information corresponding to the execution element information.

The component information corresponding to the execution element information is referred to as corresponding information in steps S113 to S115.

If there is the corresponding information, the procedure proceeds to step S115.

If there is not the corresponding information, the procedure proceeds to step S114.

In step S114, the association unit 120 generates the corresponding information.

The association unit 120 generates the corresponding information as follows, for example.

A new ID is set in an ID field.

The function name of the execution element information is set in the field of the element name of the corresponding information.

An identifier of “Function” indicating a function is set in the field of the type name of the corresponding information.

The class name of the execution element information is set in the field of the parent element of the corresponding information.

The file name of the execution element information is set in the field of the definition file of the corresponding information.

The execution line of the execution element information is set in the definition line of the corresponding information.

The hyphen of “-” is set in each of the fields of the control information and the dependent element of the corresponding information.

Then, the association unit 120 adds the generated corresponding information to the software structure file 202.

In step S115, the association unit 120 registers association information in the association file 203. The association file 203 is stored in the storage unit 191.

The association file 203 includes the association information for each set of the execution element information and the component information.

The association information associates the execution element information and the corresponding information with each other.

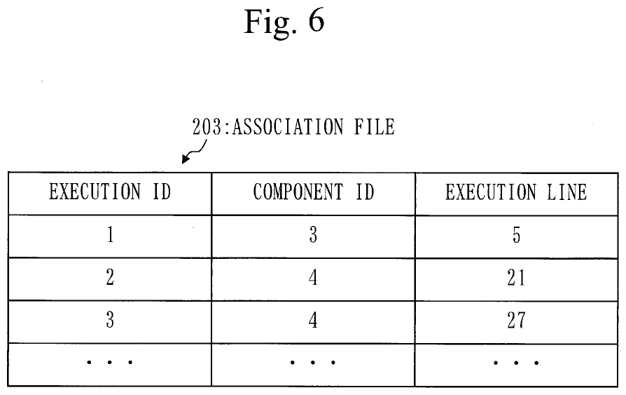

The association file 203 will be described based on FIG. 6.

The association file 203 associates an execution ID, a component ID, and the execution line with one another.

A set of the execution ID, the component ID, and the execution line constitutes the association information.

The execution ID is an identifier for the execution element information.

The component ID is an identifier for the component information.

The execution line of the association information is the same as the execution line of the execution element information.

The description in step S115 will be continued by returning to FIG. 5.

Specifically, the association unit 120 generates the association information as follows. Then, the association unit 120 registers the generated association information in the association file 203.

The association unit 120 extracts the ID and the execution line from the execution element information. The ID that is extracted is the execution ID.

Further, the association unit 120 extracts the ID from the corresponding information. The ID that is extracted is the component ID.

Then, the association unit 120 generates information including the execution ID, the component ID, and the execution line. The information that is generated is the association information.

In step S116, the association unit 120 determines whether there is the execution element information that has not been selected. In step S116, the execution element information that has not been selected is referred to as non-selected information.

If there is the non-selected information, the procedure proceeds to step S111.

If there is not the non-selected information, the procedure is finished.

In the association process (S110) in FIG. 5, the execution element information is selected from the execution history file 201, and the process is performed for the selected execution element information. However, it may be so arranged that the component information is selected from the software structure file 202 and the process is performed for the selected component information.

The description will be continued from step S120 by returning to FIG. 2.

In step S120, the determination unit 130 determines one or more important elements from the plurality of components in the target program by referring to the software structure file 202, based on the association file 203.

Then, the determination unit 130 generates an important element file 204 indicating each important element. The important element file 204 is stored in the storage unit 191.

Specifically, the important elements are each execution element and the parent element of each execution element.

The important element file 204 includes important element information for each important element. The important element information indicates the important element.

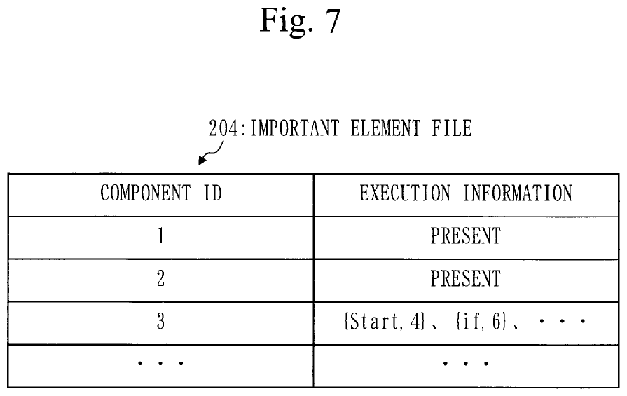

The important element file 204 will be described based on FIG. 7.

The important element file 204 associates a component ID and execution information with each other.

A set of the component ID and the execution information constitutes the important element information.

The component ID is an identifier for the component information.

The execution information indicates an execution flag or the control information.

The execution flag indicates presence or absence of execution.

The control information is the information set in the software structure file 202.

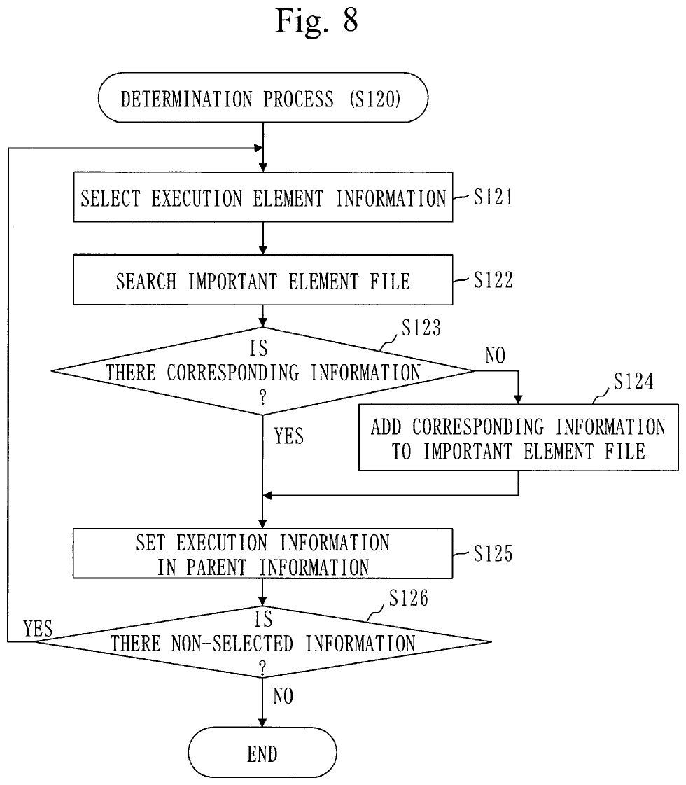

A procedure for the determination process (S120) will be described based on FIG. 8.

In step S121, the determination unit 130 selects, from the execution history file 201, one piece of the execution element information that has not been selected.

Steps S122 to S125 are executed for the execution element information that has been selected in step S121.

In step S122, the determination unit 130 searches the important element file 204, thereby searching the important element information corresponding to the execution element information.

Specifically, the determination unit 130 searches the important element file 204 in the following way.

First, the determination unit 130 extracts the ID from the execution element information.

Subsequently, the determination unit 130 selects, from the association file 203, the association information where the execution ID that is the same as the extracted ID has been set.

Subsequently, the determination unit 130 extracts the component ID from the selected association information.

Then, the determination unit 130 searches, from the important element file 204, the important element information where the component ID that is the same as the extracted component ID has been set.

In step S123, the determination unit 130 determines whether there is the important element information corresponding to the execution element information.

In steps S123 to 125, the important element information corresponding to the execution element information is referred to as corresponding information.

If there is the corresponding information, the procedure proceeds to step S125.

If there is not the corresponding information, the procedure proceeds to step S124.

In step S124, the determination unit 130 generates the corresponding information and then adds the generated corresponding information to the important element file 204.

Specifically, the determination unit 130 generates the corresponding information in the following way.

First, the determination unit 130 extracts the ID from the execution element information.

Subsequently, the determination unit 130 selects, from the association file 203, the association information where the execution ID that is the same as the extracted ID has been set.

Subsequently, the determination unit 130 extracts the component ID from the selected association information.

Subsequently, the determination unit 130 selects, from the software structure file 202, the component information including the ID that is the same as the extracted component ID.

Subsequently, the determination unit 130 extracts the control information from the selected component information.

Then, the determination unit 130 generates the important element information where the extracted component ID and the extracted control information have been set. The important element information that is generated is the corresponding information.

In step S125, the determination unit 130 selects parent information from the important element file 204 and sets the execution information in the selected parent information.

In step S125, the parent information is the important element information of the parent element corresponding to the execution element.

Specifically, the determination unit 130 operates in the following way.

First, the determination unit 130 extracts the component ID from the corresponding information.

Subsequently, the determination unit 130 selects, from the software structure file 202, the component information where the ID that is the same as the extracted component ID has been set.

Subsequently, the determination unit 130 refers to the field of the parent element of the selected component information.

If the parent element is set, the determination unit 130 selects, from the software structure file 202, the component information where the element name that is the same as that of the parent element has been set. Subsequently, the determination unit 130 extracts the ID from the selected component information. Subsequently, the determination unit 130 determines whether there is, in the important element file 204, the important element information where the component ID that is the same as the extracted ID has been set.

If there is the corresponding important element information, the determination unit 130 sets the execution flag of “present” in the field of the execution information of the corresponding important element information.

If there is not the corresponding important element information, the determination unit 130 adds, to the important element file 204, the important element information where the component ID that is the same as the extracted ID has been set. Then, the determination unit 130 sets the execution flag of “present” in the field of execution information of the added important element information.

In step S126, the determination unit 130 determines whether there is the execution element information that has not been selected. In step S126, the execution element information that has not been selected is referred to as non-selected information.

If there is the non-selected information, the procedure proceeds to step S121.

If there is not the non-selected information, the procedure is finished.

The description will be continued from step S130 by returning to FIG. 2.

In step S130, the visualization unit 140 generates a visualization diagram 205, based on the important element file 204 and the software structure file 202.

The visualization diagram 205 is a diagram that indicates the one or more important elements by visualization.

Specifically, the visualization diagram 205 illustrates the structure of the target program in a state where each important element has been emphasized.

Specifically, the visualization unit 140 generates a structure diagram based on the software structure file 202. Then, the visualization unit 140 selects the one or more important elements from the structure diagram based on the important element file 204 and then emphasizes the one or more important elements.

The visualization diagram 205 is a call graph 210 or a flowchart 220, for example.

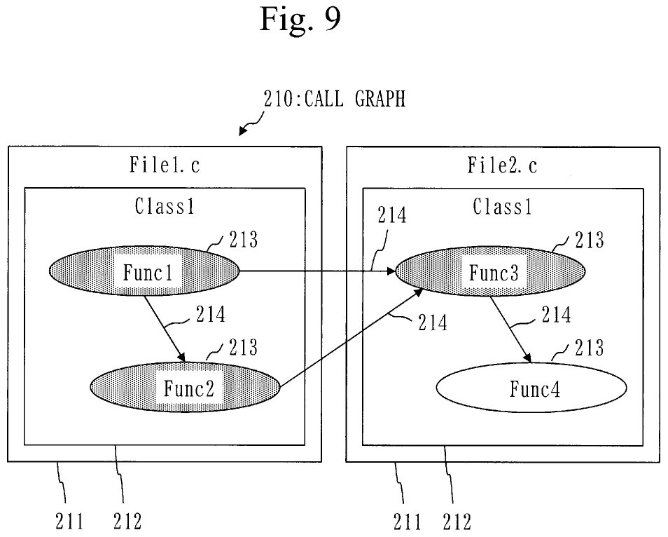

The call graph 210 will be described based on FIG. 9.

The call graph 210 indicates one or more calling relationships between functions.

The call graph 210 includes file frames 211, class frames 212, function figures 213, and call lines 214.

Each file frame 211 is a frame indicating a file.

Each class frame 212 is a frame indicating a class and is disposed within the file frame 211.

Each function figure 213 is a figure indicating a function and is disposed within the class frame 212.

Each call line 214 is a line in the form of an arrow that connects between the functions and indicates a calling relationship between the functions.

Each function figure 213 of the function that is the important element is emphasized by being filled.

Each of functions {Func1}, {Func2}, and {Func3} in FIG. 9 is the important element. On the other hand, a function {Func4} is not the important element.

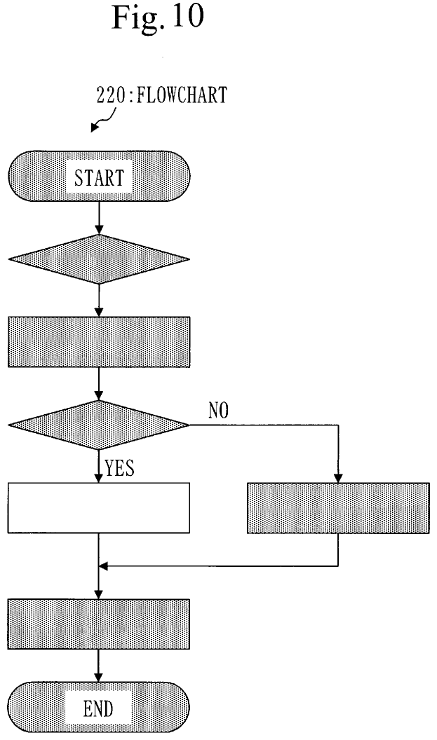

The flowchart 220 will be described based on FIG. 10.

The flowchart 220 indicates a flow of processes.

A block with respect to each important element, that is, a block with respect to each component that has been executed is emphasized by being filled.

Step S140 will be described by returning to FIG. 2.

In step S140, the output unit 150 causes a display to display the visualization diagram 205 by outputting data of the visualization diagram 205.

### Effect of First Embodiment

Each element that has been executed among the elements that constitute the program can be visualized as the important element.

This facilitates a user to determine a portion of the program to be checked. Therefore, it becomes possible to prevent overlooking of a portion that has not been executed and an error in understanding the portion that has not been executed.

### Second Embodiment

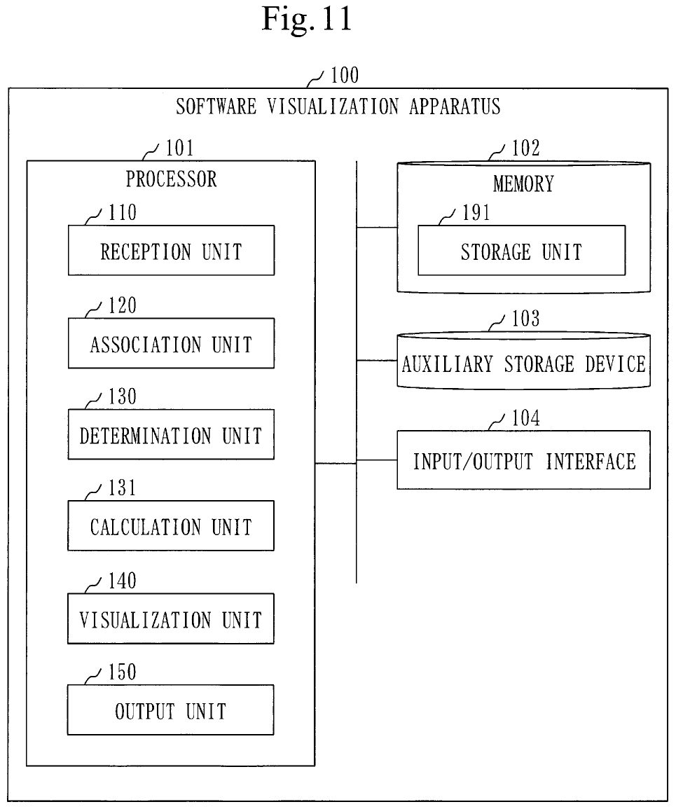

With respect to an embodiment where the degree of importance (the number of times of execution) of each important element is visualized, a difference of the embodiment from the first embodiment will be mainly described based on FIGS. 11 to 15.

***Description of Configuration***

A configuration of a software visualization apparatus 100 will be described based on FIG. 11.

The software visualization apparatus 100 further includes a calculation unit 131.

A software visualization program causes a computer to further function as the calculation unit 131.

***Description of Operations***

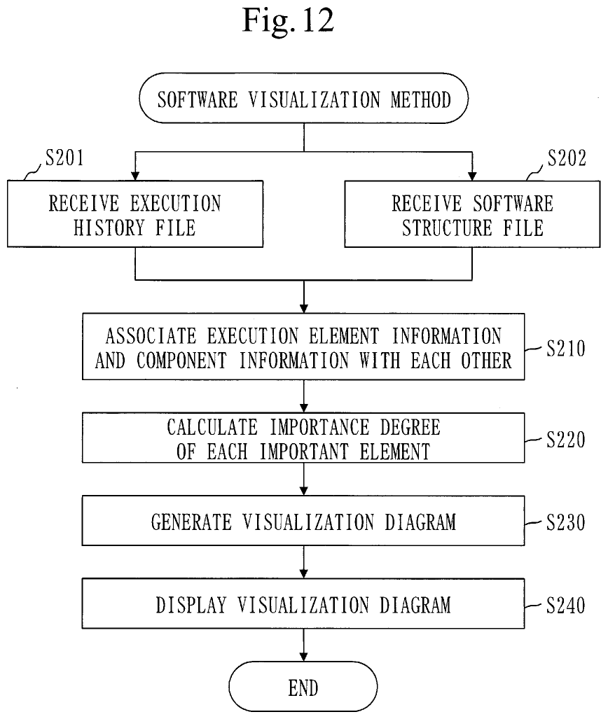

A software visualization method will be described based on FIG. 12.

In step S201, a reception unit 110 receives an execution history file 201.

Then, the reception unit 110 stores the execution history file 201 in a storage unit 191.

Step 201 is the same as step S101 (see FIG. 2) in the first embodiment.

In step S202, the reception unit 110 receives a software structure file 202.

Then, the reception unit 110 stores the software structure file 202 in the storage unit 191.

Step S202 is the same as step S102 (see FIG. 2) in the first embodiment.

In step S210, an association unit 120 associates each piece of execution element information of the execution history file 201 and each piece of component information of the software structure file 202 with each other. Then, the association unit 120 generates an association file 203.

Step S210 is the same as step S110 (see FIG. 2) in the first embodiment.

In step S220, a determination unit 130 determines one or more important elements from a target program by referring to the software structure file 202 based on the association file 203. Then, the determination unit 130 generates an important element file 204.

Further, the calculation unit 131 calculates the degree of importance of each important element based on the execution history file 201.

Specifically, the degree of importance is the number of times of execution of the important element. The more the number of times of execution is, the higher the degree of importance is.

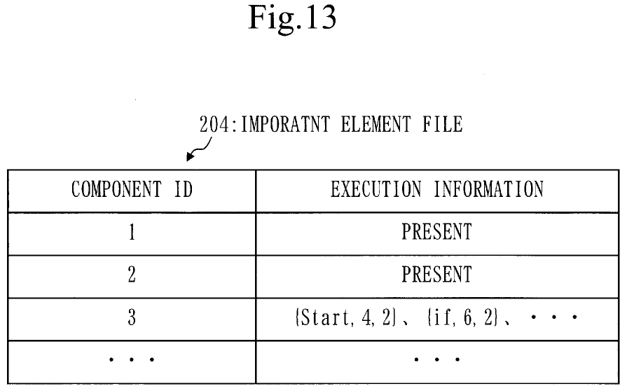

The important element file 204 will be described based on FIG. 13.

As described in the first embodiment, the important element file 204 associates a component ID and execution information with each other.

The execution information indicates an execution flag or control information.

The number of times of execution is added to the control information in the execution information.

{X, Y, A} indicates control information {X, Y} and a number of times of execution A.

{X, Y} indicates a control instruction X and a description line Y, as described before.

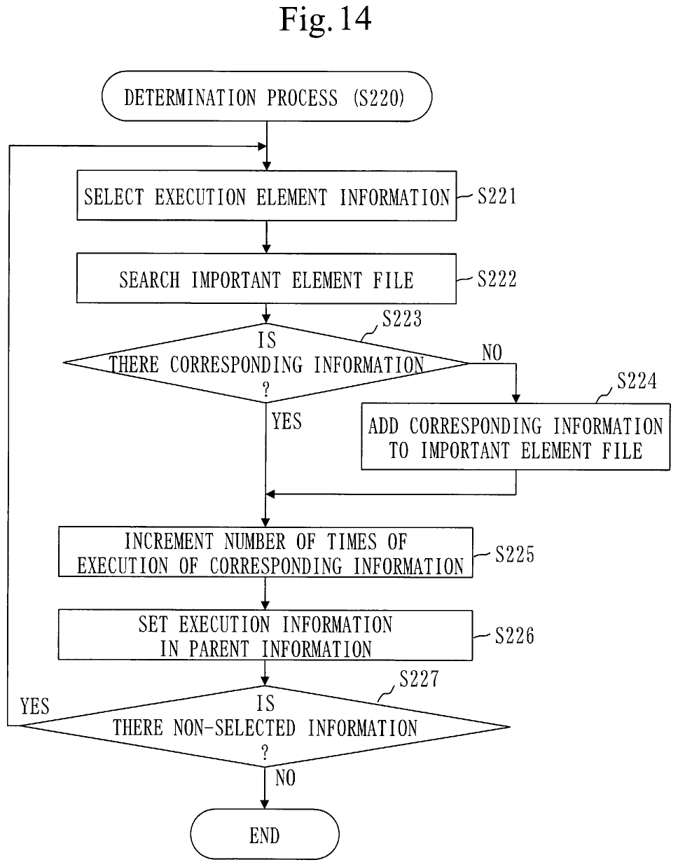

A procedure for the determination process (S220) will be described based on FIG. 14.

In step S221, the determination unit 130 selects, from the execution history file 201, one piece of the execution element information that has not been selected.

Steps S222 to S226 are executed for the execution element information that has been selected in step S221.

In step S222, the determination unit 130 searches important element information corresponding to the execution element information by searching the important element file 204.

Step S222 is the same as step S122 (see FIG. 8) in the first embodiment.

In step S223, the determination unit 130 determines whether there is the important element information corresponding to the execution element information.

In steps S223 to S226, the important element information corresponding to the execution element information is referred to as corresponding information.

If there is the corresponding information, the procedure proceeds to step S225.

If there is not the corresponding information, the procedure proceeds to step S224.

In step S224, the determination unit 130 generates the corresponding information and adds the generated corresponding information to the important element file 204.

Step S224 is the same as step S124 (see FIG. 8) in the first embodiment.

The number of times of execution that is set in the corresponding information is, however, an initial value of “0”.

In step S225, the calculation unit 131 increments the number of times of execution set in the corresponding information by 1.

In step S226, the determination unit 130 selects parent information from the important element file 204, and sets the execution information in the selected parent information.

Step S226 is the same as step S125 (see FIG. 8) in the first embodiment.

In step S227, the determination unit 130 determines whether there is the execution element information that has not been selected. In step S227, the execution element information that has not been selected is referred to as non-selected information.

If there is the non-selected information, the procedure proceeds to step S221.

If there is not the non-selected information, the procedure is finished.

The description will be continued from step S230 by returning to FIG. 12.

In step S230, a visualization unit 140 generates a visualization diagram 205 based on the important element file 204 and the software structure file 202.

Step S230 is the same as step S130 (see FIG. 2) in the first embodiment.

Each important element is, however, emphasized according to the degree of importance (the number of times of execution) in the visualization diagram 205.

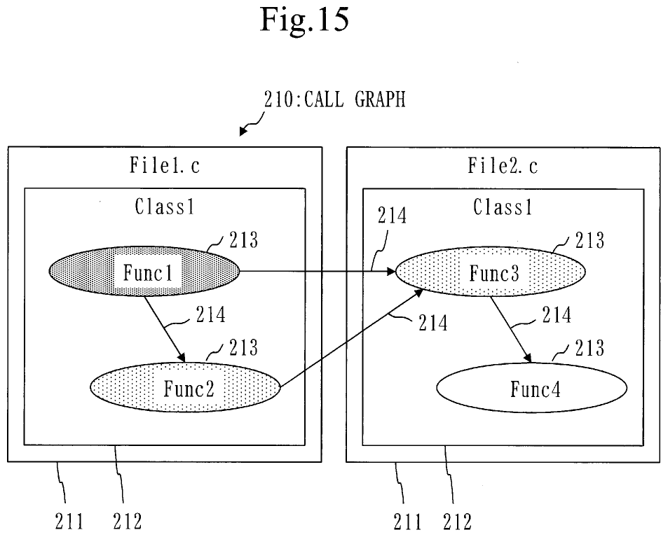

Based on FIG. 15, a description will be given about a call graph 210 where each important element has been emphasized according to the number of times of execution.

Each function figure 213 of a function that is the important element is filled in with a color corresponding to the number of times of execution.

Referring to FIG. 15, each of a function {Func1}, a function {Func2}, and a function {Func3} is the important element. Then, the function {Func1} has a larger number of times of execution than each of the function {Func2} and the function {Func3}. That is, the function {Func1} has a higher degree of importance than each of the function {Func2} and the function {Func3}.

Step 240 will be described by returning to FIG. 12.

In step S240, an output unit 150 causes a display to display the visualization diagram 205 by outputting data of the visualization diagram 205.

### Effect of Second Embodiment

The degree of importance (the number of times of execution) of each important element can be visualized.

This facilitates a user to determine a portion of the program that is frequently executed and a portion of the program that is scarcely executed. Therefore, it becomes possible to know the portion that should be preferentially checked.

### Third Embodiment

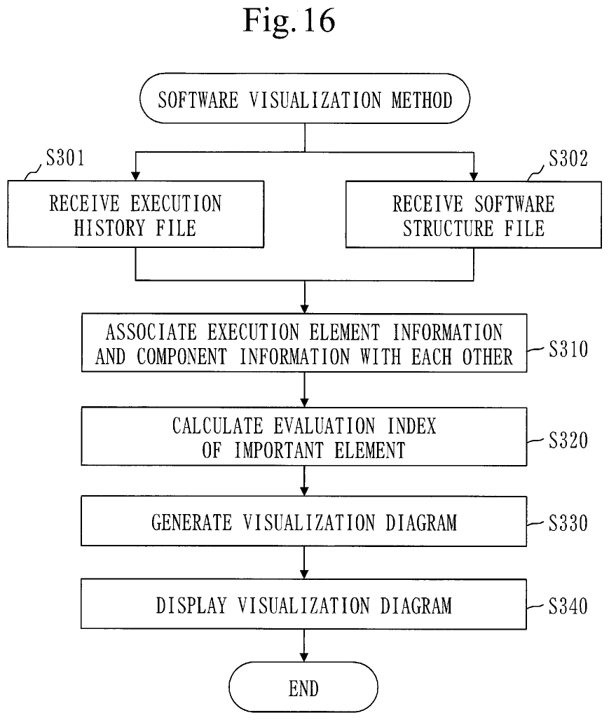

With respect to an embodiment where the degree of importance (evaluation index) of each important element is visualized, a difference of the embodiment from the first embodiment will be mainly described based on FIGS. 16 to 20.

***Description of Configuration***

A configuration of a software visualization apparatus 100 is the same as that (see FIG. 11) in the second embodiment.

***Description of Operations***

A software visualization method will be described based on FIG. 16.

In step S301, a reception unit 110 receives an execution history file 201.

Then, the reception unit 110 stores the execution history file 201 in a storage unit 191.

Step S301 is the same as step S101 (see FIG. 2) in the first embodiment.

In step S302, the reception unit 110 receives a software structure file 202.

Then, the reception unit 110 stores the software structure file 202 in the storage unit 191.

Step S302 is the same as step S102 (see FIG. 2) in the first embodiment.

In step S310, an association unit 120 associates each piece of execution element information of the execution history file 201 and each piece of component information of the software structure file 202 with each other. Then, the association unit 120 generates an association file 203.

Step S310 is the same as step S110 (see FIG. 2) in the first embodiment.

In step S320, a determination unit 130 determines, from a target program, one or more important elements, based on the association file 203.

Specifically, the determination unit 130 selects one or more execution elements and one or more parent elements of the one or more execution elements, as the one or more important elements.

Further, a calculation unit 131 calculates the degree of importance of each important element, based on the software structure file 202.

Specifically, the degree of importance is the evaluation index that is obtained by evaluating the important element. The higher the evaluation index is, the higher the degree of importance is.

The evaluation index of a function is, for example, the number of lines, a cyclomatic complexity, the number of fan-ins, the number of fan-outs, or a combination of these values.

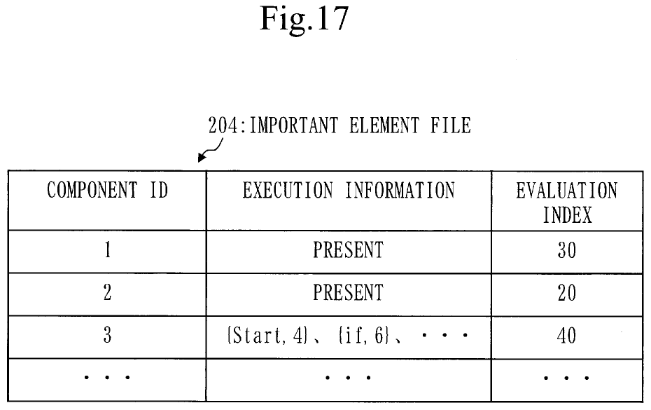

An important element file 204 will be described based on FIG. 17.

The important element file 204 associates a component ID, execution information, and the evaluation index with one another.

A set of the component ID, the execution information, and the evaluation index constitutes each piece of important element information.

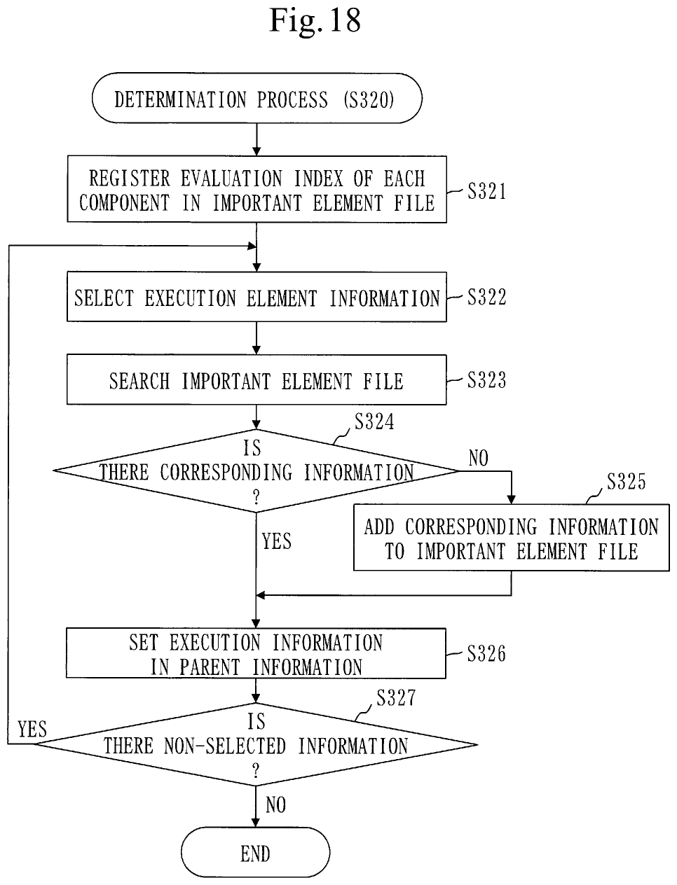

A procedure for the determination process (S320) will be described based on FIG. 18.

In step S321, the determination unit 130 registers the evaluation index of each component in the important element file.

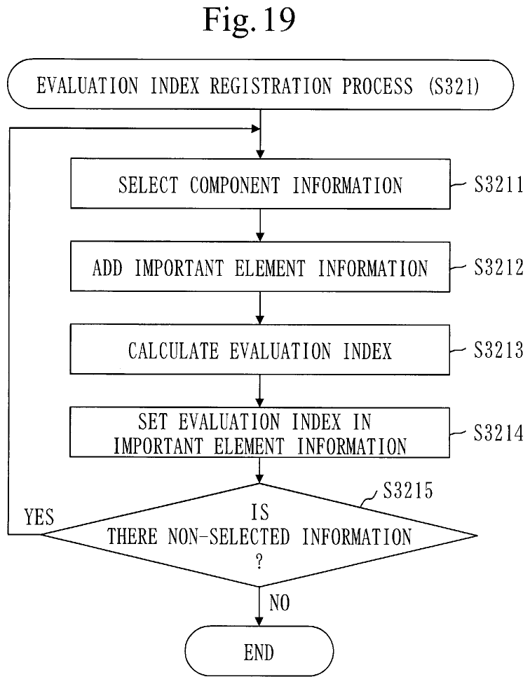

A procedure for the evaluation index registration process (S321) will be described based on FIG. 19.

In step S3211, the determination unit 130 selects, from the software structure file 202, one piece of the component information that has not been selected.

Step S3212 to step S3214 are executed for the component information that has been selected in step S3211.

In step S3212, the determination unit 130 generates important element information where a component ID that is the same as the ID of the component information has been set.

Then, the determination unit 130 adds the generated important element information to the important element file 204.

The respective fields of execution information and an evaluation index are blank in the important element information that is added.

In step S3213, the determination unit 130 calculates the evaluation index, based on the component information.

In step S3214, the determination unit 130 sets the evaluation index in the added important element information.

In step S3215, the determination unit 130 determines whether there is the component information that has not been selected. In step S3215, the component information that has not been selected is referred to as non-selected information.

If there is the non-selected information, the procedure proceeds to step S3211.

If there is not the non-selected information, the procedure is finished.

The description will be continued from step S322 by returning to FIG. 18.

Step S322 to step S327 are the same as step S121 to step S126 in the first embodiment (see FIG. 8).

The description will be continued from step S330 by returning to FIG. 16.

In step S330, a visualization unit 140 generates data of a visualization diagram 205, based on the important element file 204 and the software structure file 202.

Step S330 is the same as step S130 (see FIG. 2) in the first embodiment.

The visualization unit 140, however, emphasizes each important element according to the degree of importance (evaluation index).

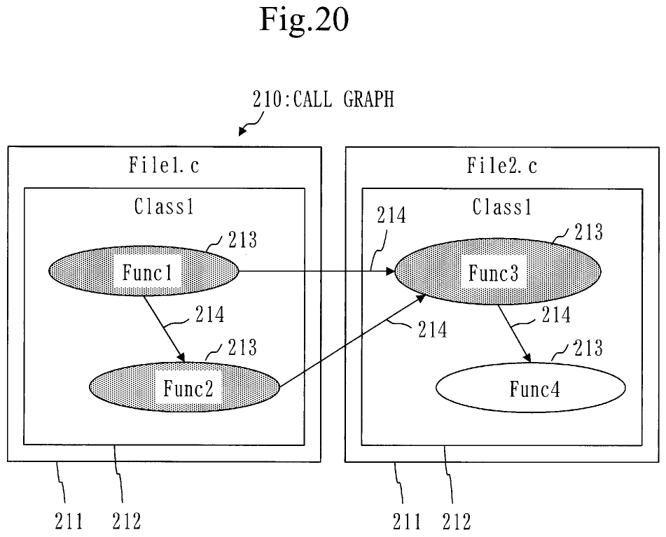

Based on FIG. 20, a description will be given about a call graph 210 where each important element has been emphasized according to the evaluation index.

Each function figure 213 of a function that is the important element is written in the size corresponding to the evaluation index.

Referring to FIG. 20, each of a function {Func1}, a function {Func2}, and a function {Func3} is the important element. Then, the function {Func3} has a higher evaluation index than each of the function {Func1} and the function {Func2}. That is, the function {Func3} has a higher degree of importance than each of the function {Func1} and the function {Func2}.

Step S340 will be described by returning to FIG. 16.

In step S340, an output unit 150 causes a display to display the visualization diagram 205 by outputting the data of the visualization diagram 205.

### Effect of Third Embodiment

The degree of importance (evaluation index) of each important element can be visualized.

This facilitates a user to determine a portion to be noticed in the program. Therefore, it becomes possible to know the portion to be selectively checked even if the execution frequency of the portion is low.

### Fourth Embodiment

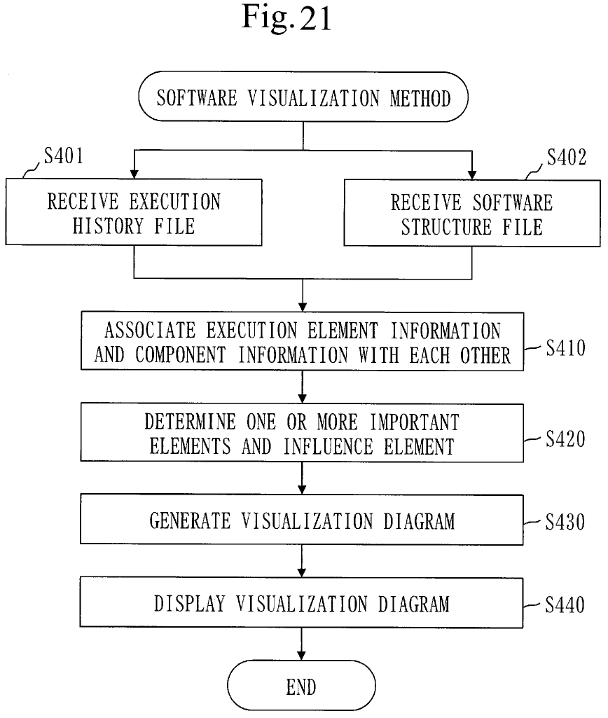

With respect to an embodiment where an influence element that will be influenced by each important element is visualized, a difference of the embodiment from the first embodiment will be mainly described based on FIGS. 21 to 25.

***Description of Configuration*** A configuration of a software visualization apparatus 100 is the same as the configuration (see FIG. 1) in the first embodiment.

***Description of Operations***

A software visualization method will be described based on FIG. 21. In step S401, a reception unit 110 receives an execution history file 201. Then, the reception unit 110 stores the execution history file 201 in a storage unit 191.

Step S401 is the same as step S101 (see FIG. 2) in the first embodiment.

In step S402, the reception unit 110 receives a software structure file 202.

Then, the reception unit 110 stores the software structure file 202 in the storage unit 191.

Step S402 is the same as step S102 (see FIG. 2) in the first embodiment.

In step S410, an association unit 120 associates each piece of execution element information of the execution history file 201 and each piece of component information of the software structure file 202 with each other. Then, the association unit 120 generates an association file 203.

Step S410 is the same as step S110 (see FIG. 2) in the first embodiment.

In step S420, a determination unit 130 determines one or more important elements from a target program by referring to the software structure file 202 based on the association file 203. Then, the determination unit 130 generates an important element file 204.

Further, the determination unit 130 determines an influence element based on the software structure file 202.

The influence element is a component that will be influenced from each important element.

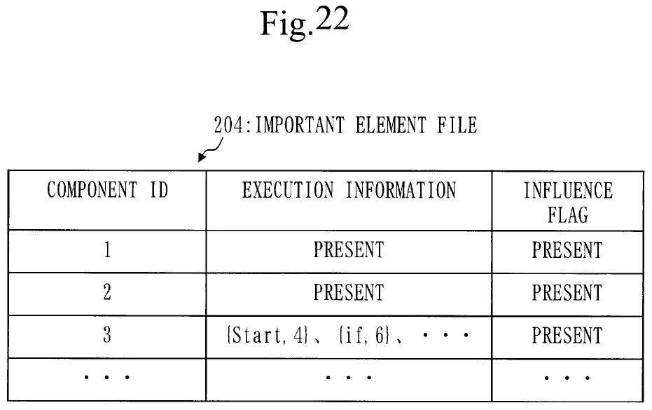

The important element file 204 will be described based on FIG. 22.

The important element file 204 associates a component ID, execution information, and an influence flag with one another.

A set of the component ID, the execution information, and the influence flag constitutes each piece of important element information.

The influence flag indicates whether or not the component is the influence element.

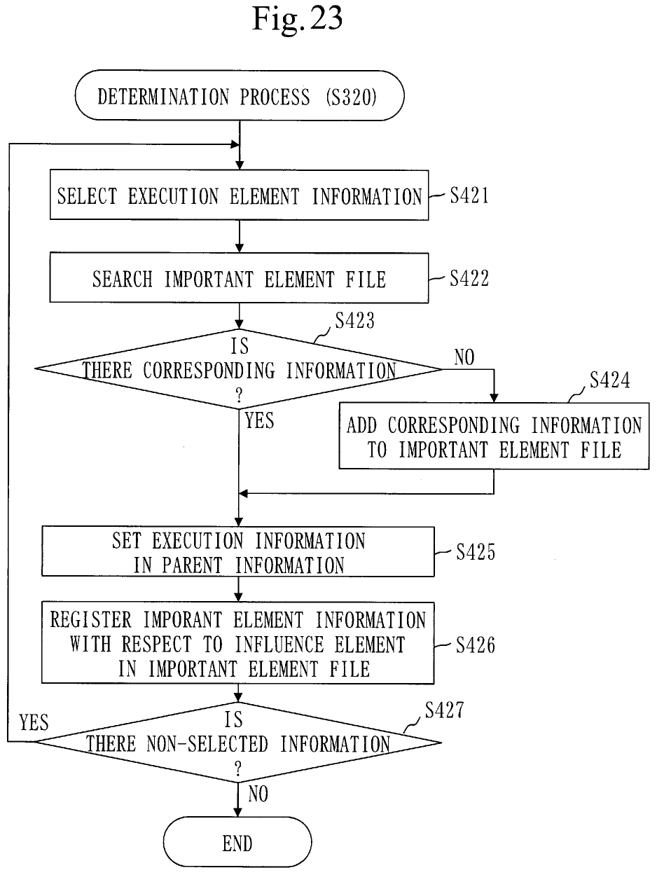

A procedure for the determination process (S420) will be described based on FIG. 23.

Step S421 to step S425 are the same as step S121 to step S125 in the first embodiment (see FIG. 8).

Further, step S427 is the same as step S126 in the first embodiment.

Hereinafter, step S426 will be described.

In step S426, the determination unit 130 registers, in the important element file 204, important element information with respect to the influence element.

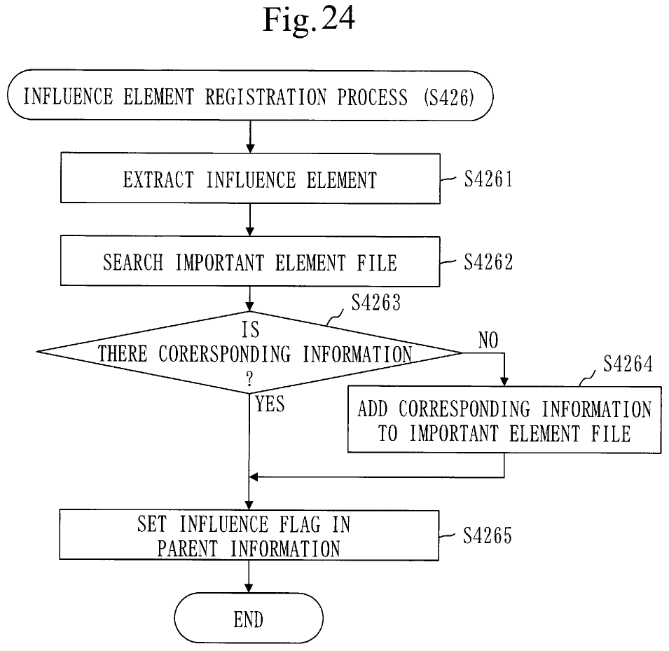

A procedure for the influence element registration process (S426) will be described based on FIG. 24.

In step S4261, the determination unit 130 extracts the influence element from the software structure file 202.

Specifically, the determination unit 130 extracts the influence element in the following way.

First, the determination unit 130 extracts the component ID from the important element information of each execution element.

Then, the determination unit 130 selects, from the software structure file 202, the component information having an ID that is the same as the extracted component ID set therein.

Then, the determination unit 130 extracts one or more dependent elements from the component information. Each of the one or more dependent elements that are extracted is the influence element.

In step S4262, the determination unit 130 searches the important element file 204, thereby searching the important element information of the influence element.

Specifically, the determination unit 130 searches the important element file 204 in the following way.

First, the determination unit 130 selects, from the software structure file 202, the component information where the element name of the influence element has been set.

Subsequently, the determination unit 130 extracts an ID from the selected component information.

Then, the determination unit 130 searches, from the important element file 204, the important element information where the component ID that is the same as the extracted ID has been set.

In step S4263, the determination unit 130 determines whether there is the important element information of the influence element.

The important element information of the influence element is referred to as corresponding information in step S4263 to step S4265.

If there is the corresponding information, the procedure proceeds to step S4265.

If there is not the corresponding information, the procedure proceeds to step S4264.

In step S4264, the determination unit 130 generates the corresponding information, and adds the generated corresponding information to the important element file 204.

Specifically, the determination unit 130 generates the corresponding information in the following way.

First, the determination unit 130 selects, from the software structure file 202, the component information where the element name of the influence element has been set.

Subsequently, the determination unit 130 extracts the ID from the selected component information.

Then, the determination unit 130 generates the important element information where the component ID that is the same as the extracted ID has been set.

The influence flag of “present” is set in the important element information that is generated. Further, the field of execution information is blank.

In step S4265, the determination unit 130 selects parent information from the important element file 204 and then, sets the influence flag in the selected parent information.

In step S4265, the parent information is the important element information of the parent element corresponding to the influence element.

Specifically, the determination unit 130 operates in the following way.

First, the determination unit 130 extracts the component ID from the corresponding information.

Then, the determination unit 130 selects, from the software structure file 202, the component information having an ID that is the same as the extracted component ID set therein.

Subsequently, the determination unit 130 refers to the field of the parent element in the selected component information.

If the parent element is set, the determination unit 130 selects, from the software structure file 202, the component information where an element name which is the same as that of the parent element set therein. Subsequently, the determination unit 130 extracts an ID from the selected component information. Subsequently, the determination unit 130 determines whether there is the important element information where the component ID that is the same as the extracted ID has been set.

If there is the corresponding important element information, the determination unit 130 sets the influence flag of “present” in the corresponding important element information.

If there is not the corresponding important element information, the determination unit 130 adds, to the important element file 204, the important element information where the component ID that is the same as the extracted ID has been set. Then, the determination unit 130 sets the influence flag of “present” in the added important element information.

The description will be continued from step S430 by returning to FIG. 21.

In step S430, a visualization unit 140 generates a visualization diagram 205 based on the important element file 204 and the software structure file 202.

Step S430 is the same as step S130 (see FIG. 2) in the first embodiment.

The visualization unit 140, however, emphasizes each influence element in a state where a distinction has been made from each important element. The influence element is a component corresponding to the important element information where the influence flag of “present” has been set.

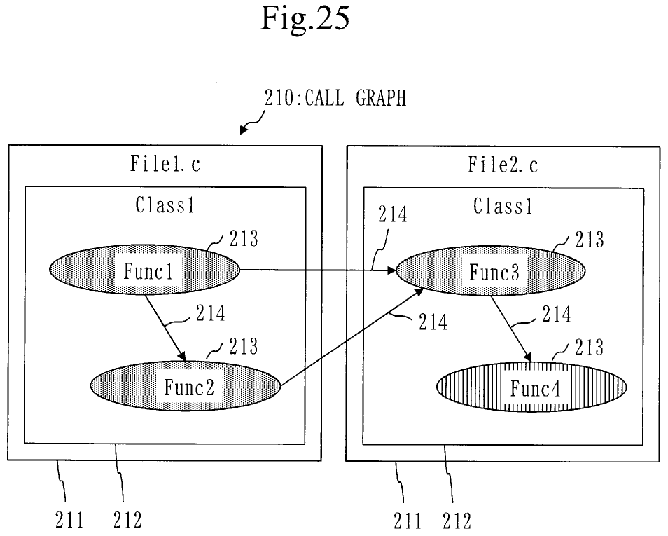

Based on FIG. 25, a description will be given about a call graph 210 where each important element and each influence element have been emphasized.

Each function figure 213 of a function that is the important element is filled in with a first color.

A function figure 213 of a function that is the influence element is filled in with a second color.

Referring to FIG. 25, each of a function {Func1}, a function {Func2}, and a function {Func3} is the important element. A function {Func4} is the influence element.

The function figure 213 of the function {Func4} is filled in with a color which is different from that of the function figure 213 of each of the function {Func1}, the function {Func2}, and the function {Func3}.

Step S440 will be described by returning to FIG. 21.

In step S440, an output unit 150 causes a display to display the visualization diagram 205 by outputting data of the visualization diagram 205.

### Effect of Fourth Embodiment

The influence element that will be influenced by each important element can be visualized.

This makes it possible for a user to know a portion of the program to be checked, together with a portion of the program that has been executed.

### Fifth Embodiment

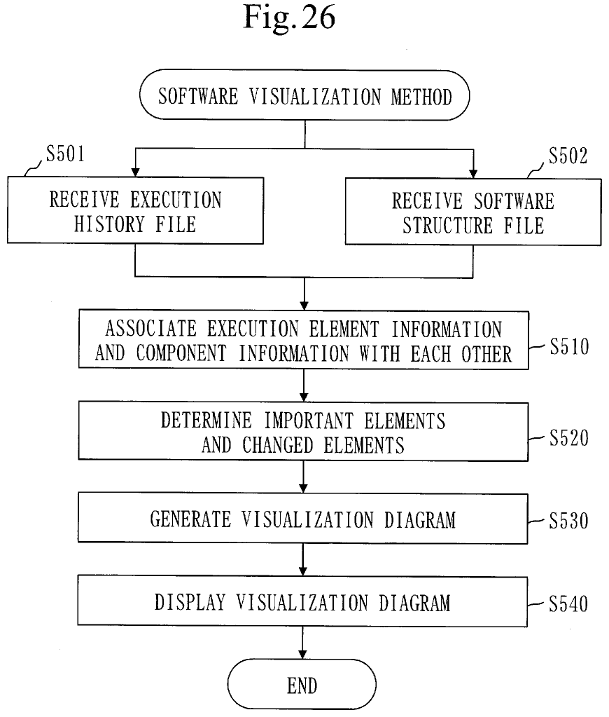

With respect to an embodiment where one or more changed elements that have been changed due to an update of the program is visualized, a difference of the embodiment from the first embodiment will be mainly described based on FIGS. 26 to 31.

***Description of Configuration***

A configuration of a software visualization apparatus 100 is the same as that (see FIG. 1) in the first embodiment.

***Description of Operations***

A software visualization method will be described based on FIG. 26.

In step S501, a reception unit 110 receives an execution history file 201.

Then, the reception unit 110 stores the execution history file 201 in a storage unit 191.

Step S501 is the same as step S101 (see FIG. 2) in the first embodiment.

In step S502, the reception unit 110 receives a software structure file 202.

Then, the reception unit 110 stores the software structure file 202 in the storage unit 191.

Step S502 is the same as step S102 (see FIG. 2) in the first embodiment.

However, the software structure file 202 has a configuration which is partially different from that in the first embodiment.

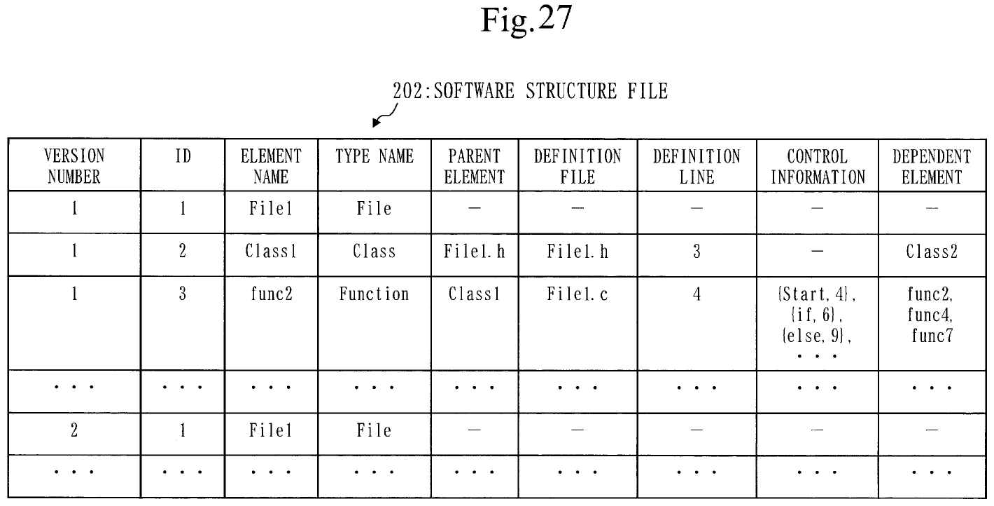

The software structure file 202 will be described based on FIG. 27.

The software structure file 202 has a version number, in addition to the items described in the first embodiment (see FIG. 4).

The version number identifies the version of the program.

The software structure file 202 corresponds to a plurality of software structure files associated with a plurality of programs having different versions.

Specifically, the software structure file 202 includes information of the software structure file of the target program and information of the software structure file of a reference program.

The target program is a program with a version to be visualized.

The reference program is a program with a version to be compared with the target program.

The description will be continued from step S510 by returning to FIG. 26.

In step S510, an association unit 120 associates each piece of execution element information of the execution history file 201 and each piece of component information of the software structure file 202 with each other. Then, the association unit 120 generates an association file 203.

Step S510 is the same as step S110 (see FIG. 2) in the first embodiment.

The component information to be associated with the execution element information is, however, the component information of the target program.

In step S520, the determination unit 130 determines one or more important elements from the target program by referring to the software structure file 202 based on the association file 203. Then, the determination unit 130 generates an important element file 204.

Further, the determination unit 130 determines one or more changed elements, based on the software structure file 202.

Each changed element is a component of a plurality of components of the target program, which is different from any component of the reference program.

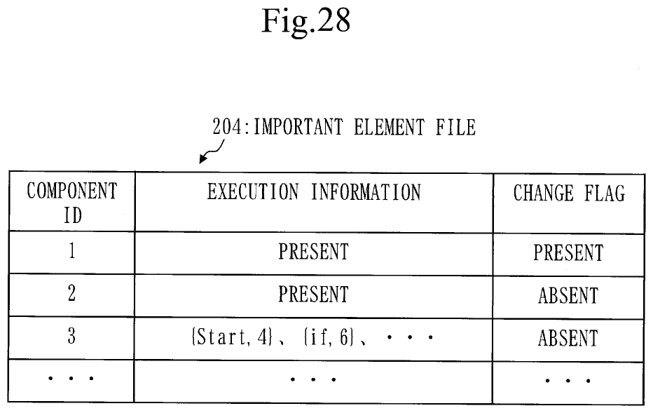

The important element file 204 will be described based on FIG. 28.

The important element file 204 associates a component ID, execution information, and a change flag are associated with one another.

A set of the component ID, the execution information, and the change flag constitutes each piece of important element information.

The change flag indicates whether or not the component is the changed element.

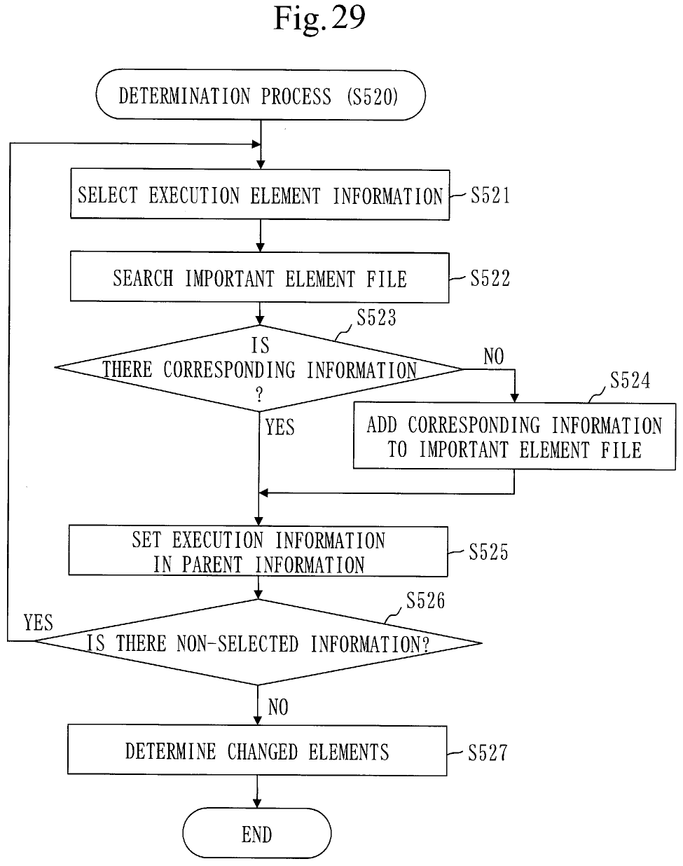

A procedure for the determination process (S520) will be described based on FIG. 29.

Step S521 to step S526 are the same as step S121 to step S126 in the first embodiment (see FIG. 8).

The change flag of “absent” is, however, set in each piece of the important element information in the important element file 204.

In step S527, the determination unit 130 determines the one or more changed elements, based on the software structure file 202.

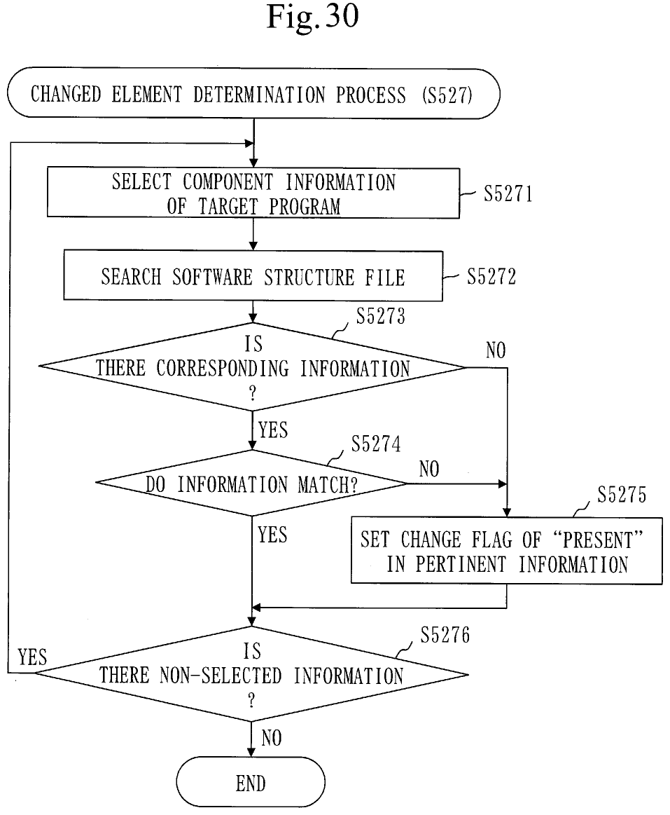

A procedure for the changed element determination process (S527) will be described based on FIG. 30.

In step S5271, the determination unit 130 selects, from the software structure file 202, one piece of the component information in the target program, which has not been selected.

That is, the determination unit 130 selects the one piece of the component information that has not been selected from a plurality of pieces of the component information where the version number of the target program has been set.

Step S5272 to step S5275 are executed for the component information that has been selected in step S5271.

In step S5272, the determination unit 130 searches the software structure file 202, thereby searching the component information of the reference program corresponding to the component information of the target program.

Specifically, the determination unit 130 searches the software structure file 202 in the following way.

First, the determination unit 130 extracts an ID from the component information of the target program.

Then, the determination unit 130 searches, from the software structure file 202, the component information where the version number of the reference program and an ID that is the same as the extracted ID have been set.

In step S5273, the determination unit 130 determines whether there is the component information of the reference program corresponding to the component information of the target program.

The component information of the reference program corresponding to the component information of the target program is referred to as corresponding information in step S5273 to step S5275.

If there is the corresponding information, the procedure proceeds to step S5274.

If there is not the corresponding information, the procedure proceeds to step S5275.

In step S5274, the determination unit 130 compares the component information of the target program with the component information of the reference program (corresponding information), excluding the version numbers.

If the component information of the target program matches the component information of the reference program (corresponding information), the procedure proceeds to step S5276.

If the component information of the target program does not match the component information of the reference program (corresponding information), the procedure proceeds to step S5275.

In step S5275, the determination unit 130 searches the important element file 204, thereby searching the important element information corresponding to the corresponding information.

Specifically, the determination unit 130 searches the important element file 204 in the following way.

First, the determination unit 130 extracts an ID from the corresponding information.

Then, the determination unit 130 searches, from the important element file 204, the important element information where the component ID that is the same as the extracted ID has been set.

In step S5275, the important element information corresponding to the corresponding information is referred to as pertinent information.

If there is the pertinent information, the determination unit 130 sets the change flag of “present” in the pertinent information.

If there is not the pertinent information, the determination unit 130 generates the important element information where the component ID that is the same as the ID of the corresponding information has been set, and then adds the generated important element information to the important element file 204. Then, the determination unit 130 sets the change flag of “present” in the added important element information.

In step S5276, the determination unit 130 determines whether there is the component information of the target program, which has not been selected.

In step S5276, the component information of the target program that has not been selected is referred to as non-selected information.

If there is the non-selected information, the procedure proceeds to step S5271.

If there is not the non-selected information, the procedure is finished.

The description will be continued from step S530 by returning to FIG. 26.

In step S530, a visualization unit 140 generates a visualization diagram 205 based on the important element file 204 and the software structure file 202.

Step S530 is the same as step S130 in the first embodiment (see FIG. 2).

However, the visualization unit 140 emphasizes each changed element in a state where a distinction has been made from each important element. The changed element is the component corresponding to the important element information where the change flag of “present” has been set.

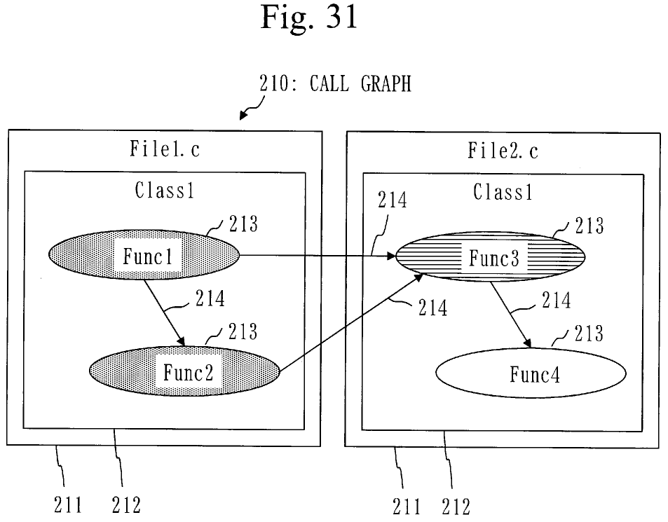

A description will be given about call graph 210 where each important element and each changed element have been emphasized, based on FIG. 31.

Each function figure 213 of a function that is the important element is filled in with a first color.

A function figure 213 of a function that is the changed element is filled in with a second color.

Referring to FIG. 31, each of a function {Func1}, and a function {Func2} is the important element. A function {Func3} is an influence element.

The function figure 213 of the function {Func3} is filled in with a color which is different from that of each of the function {Func1} and the function {Func2}.

Step S540 will be described by returning to FIG. 26.

In step S540, an output unit 150 causes a display to display the visualization diagram 205 by outputting data of the visualization diagram 205.

### Effect of Fifth Embodiment

The one or more changed elements that have been changed due to the update of the program can be visualized.

This makes it possible for a user to know a portion that has been changed in the program, together with a portion that has been executed in the program.

### Sixth Embodiment

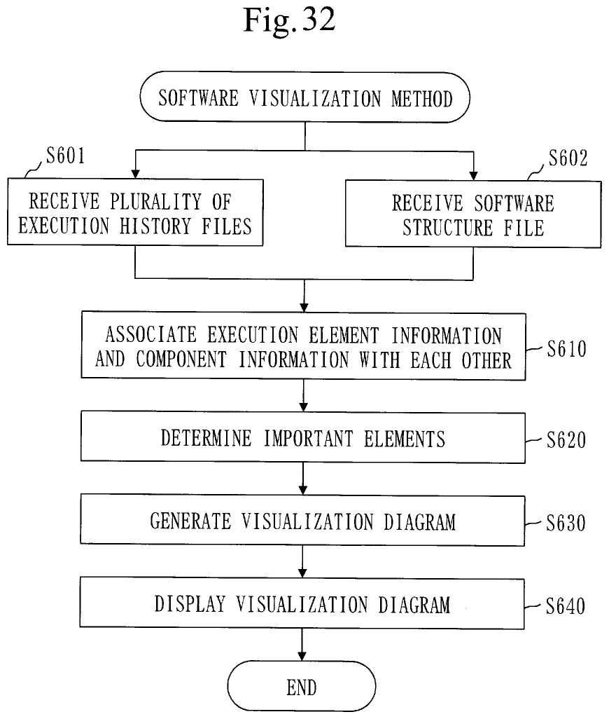

With respect to an embodiment using a plurality of execution history files 201 obtained by executing a target program a plurality of times, a difference of the embodiment from the first embodiment will be mainly described based on FIGS. 32 to 34.

***Description of Configuration***

A configuration of a software visualization apparatus 100 is the same as that in the first embodiment (see FIG. 1).

***Description of Operations*** A software visualization method will be described based on FIG. 32.

In step S601, a reception unit 110 receives a plurality of execution history files 201.

Then, the reception unit 110 stores the plurality of execution history files 201 in a storage unit 191.

The plurality of execution history files 201 is obtained by executing the target program a plurality of times.

In step S602, the reception unit 110 receives a software structure file 202.

Then, the reception unit 110 stores the software structure file 202 in the storage unit 191.

Step S602 is the same as step S102 in the first embodiment (see FIG. 2).

In step S610, an association unit 120 selects two or more execution history files 201 from the plurality of execution history files 201. The association unit 120 associates each piece of execution element information of the selected two or more execution history files 201 and each piece of component information of the software structure file 202 with each other. Then, the association unit 120 generates an association file 203.

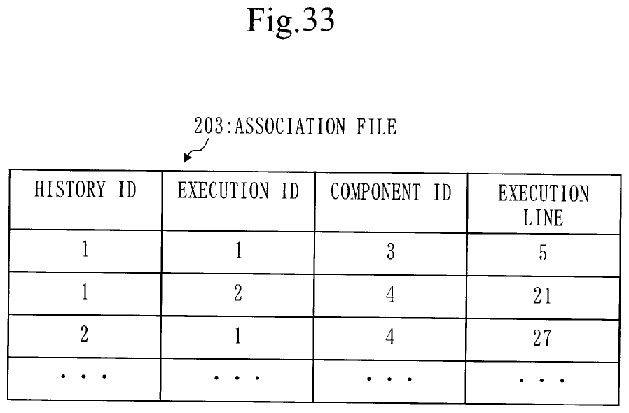

The association file 203 will be described based on FIG. 33.

The association file 203 associates a history ID, an execution ID, a component ID, and an execution line with one another.

A set of the history ID, the execution ID, the component ID, and the execution line constitutes each piece of association information.

The history ID is an identifier for the execution history file 201.

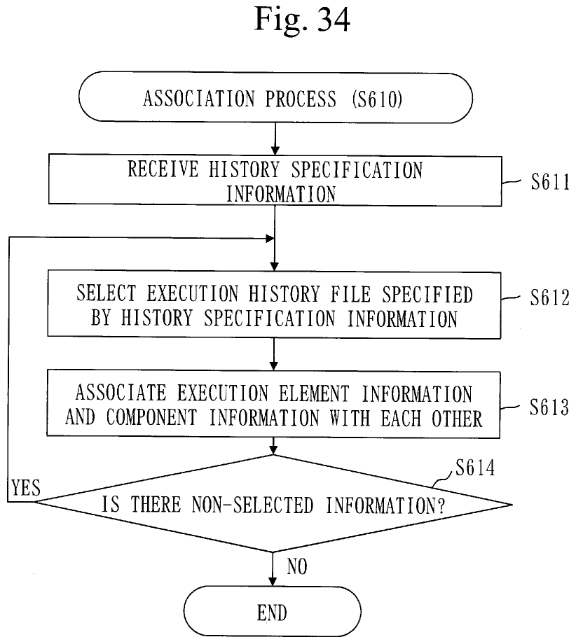

The association process (S610) will be described based on FIG. 34.

In step S611, the reception unit 110 receives history specification information.

The history specification information is information to specify the two or more execution history files 201 of the plurality of execution history files 201.

Specifically, the history specification information includes two or more history IDs.

In step S612, the association unit 120 selects, from the two or more execution history files 201 that have been specified by the history specification information, one execution history file 201 that has not been selected.

Step S613 is executed for the execution history file 201 that has been selected in step S612.

In step S613, the association unit 120 associates each piece of the execution element information of the execution history file 201 and each piece of the component information of the software structure file 202 with each other.

The process in step S613 is the same as step S110 in the first embodiment (see FIG. 5).

In step S614, the association unit 120 determines whether there is the execution history file 201 that has not been selected out of the two or more execution history files 201 that have been specified by the history specification information. The execution history file 201 that has not been selected is referred to as a non-selected file, in step S614.

If there is the non-selected file, the procedure proceeds to step S611.

If there is not the non-selected file, the procedure is finished.

Step S620 to step S640 will be described by returning to FIG. 32.

Step S620 to step S640 are the same as step S120 to step S140 in the first embodiment (see FIG. 2).

### Effect of Sixth Embodiment

A portion to be checked can be visualized by joining a plurality of execution histories. That is, the portion to be checked can be visualized by combining the two or more execution history files 201.

### Seventh Embodiment

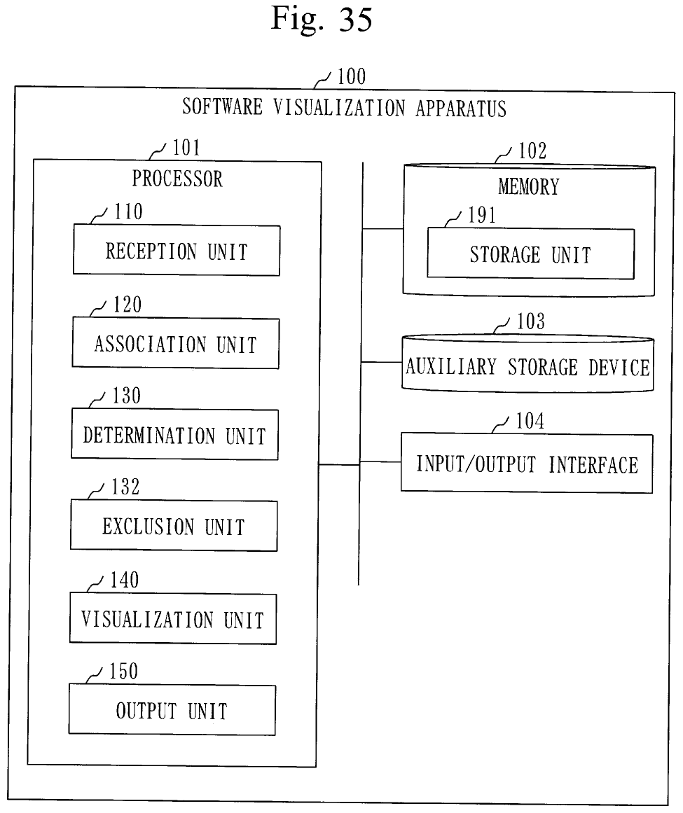

With respect to an embodiment where one or more components for which checking is not necessary are excluded from important elements, a difference of the embodiment from the first embodiment and the fifth embodiment will be mainly described based on FIG. 35 to FIG. 38.

***Description of Configuration***

A configuration of a software visualization apparatus 100 will be described based on FIG. 35.

The software visualization apparatus 100 further includes an exclusion unit 132.

A software visualization program causes a computer to further function as the exclusion unit 132.

***Description of Operations***

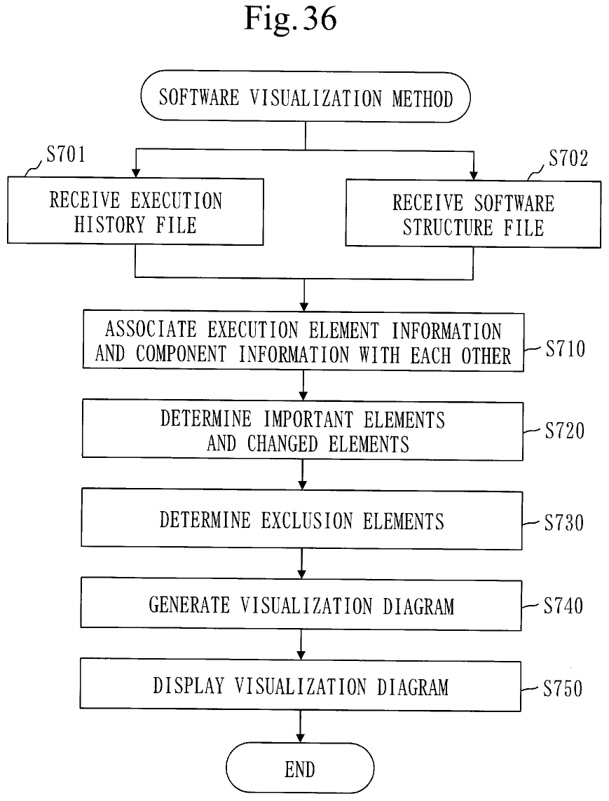

A software visualization method will be described based on FIG. 36.

In step S701, a reception unit 110 receives an execution history file 201.

Then, the reception unit 110 stores the execution history file 201 in a storage unit 191.

Step S701 is the same as step S101 in the first embodiment (see FIG. 2).

In step S702, the reception unit 110 receives a software structure file 202.

Then, the reception unit 110 stores the software structure file 202 in the storage unit 191.

Step S702 is the same as step S102 in the first embodiment (see FIG. 2).

The software structure file 202 has a configuration which is the same as that in the fifth embodiment (see FIG. 27).

In step S710, an association unit 120 associates each piece of execution element information of the execution history file 201 and each piece of component information of the software structure file 202 with each other. Then, the association unit 120 generates an association file 203.

Step S710 is the same as step S110 in the first embodiment (see FIG. 2).

The component information that is associated with the execution element information is component information of a target program, as in the fifth embodiment.

In step S720, the determination unit 130 determines one or more important elements from the target program by referring to the software structure file 202 based on the association file 203. Then, the determination unit 130 generates an important element file 204.

Further, the determination unit 130 determines one or more changed elements, based on the software structure file 202.

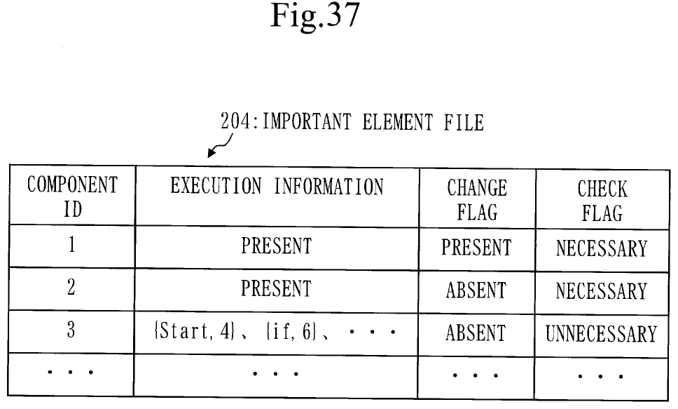

The important element file 204 will be described based on FIG. 37.

The important element file 204 associates a component ID, execution information, a change flag, and a check flag with one another.

A set of the component ID, the execution information, the change flag, and the check flag constitutes each piece of important element information.

The check flag indicates whether or not the important element is an exclusion element.

The exclusion element is a component for which checking is not necessary. Specifically, the exclusion element is the important element that is not a changed element nor an influence element that will be influenced by the changed element.

The description will be continued by returning to FIG. 36.

Step S720 is the same as step S520 in the fifth embodiment (see FIG. 26).

The important element file 204, where the change flag of each piece of the important element information has been set, is generated by step S720. The field of the check flag in each piece of the important element information is blank.

In step S730, the exclusion unit 132 determines one or more exclusion elements, based on the software structure file 202.

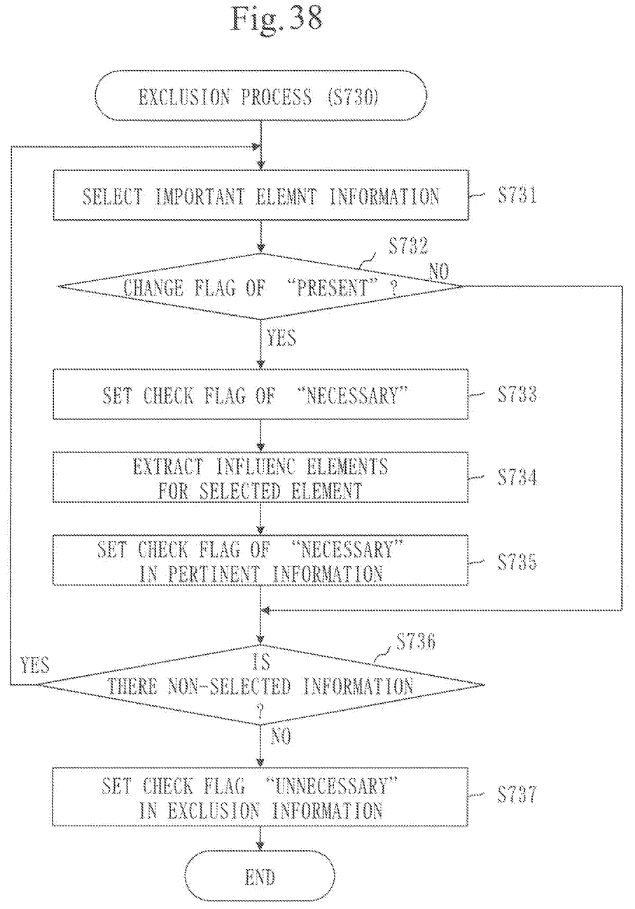

A procedure for the exclusion process (S730) will be described based on FIG. 38.

In step S731, the exclusion unit 132 selects, from the important element file 204, one piece of the important element information that has not been selected.

Step S732 to step S735 are executed for the important element information that has been selected in step S731.

Referring to step S732 to step S735, the important element information that has been selected in step S731 is referred to as selected information. The important element corresponding to the selected information is referred to as a selected element.

In step S732, the exclusion unit 132 determines whether the change flag of “present” is set in the selected information. That is, the extraction unit 132 determines whether the selected element is the changed element.

If the change flag of “present” is set in the selected information, the procedure proceeds to step S733.

If the change flag of “absent” is set in the selected information, the procedure proceeds to step S736.

In step S733, the exclusion unit 132 sets the check flag of “necessary” in the selected information.

In step S734, the exclusion unit 132 extracts, from the software structure file 202, one or more influence elements for the selected element.

The one or more influence elements for the selected element include the component of the caller of the selected element and a component of the callee of the selected element. The component of the callee includes a component that has been called from the component of the callee as well.

The one or more influence elements for the selected element may be influenced by a change of the selected element or the influence of the change of the selected element may spread to the one or more influence elements.

Specifically, the exclusion unit 132 extracts the one or more influence elements for the selected element in the following way.

First, the exclusion unit 132 extracts the component ID from the selected information.

Subsequently, the exclusion unit 132 selects, from the software structure file 202, the component information having an ID that is the same as the extracted component ID set therein.

Then, the determination unit 130 extracts one or more dependent elements from the component information. The one or more dependent elements that are extracted are the one or more influence elements for the selected element.

In step S735, the exclusion unit 132 searches the important element file 204, thereby searching the important element information of each influence element for the selected element.

Specifically, the exclusion unit 132 searches the important element file 204 in the following way.

First, the exclusion unit 132 selects, from the software structure file 202, the component information where the element name of each influence element for the selected element has been set.

Subsequently, the exclusion unit 132 extracts an ID from the selected component information. The ID that is extracted is referred to as a pertinent ID.

Then, the exclusion unit 132 searches, from the important element file 204, the important element information where the component ID that is the same as the pertinent ID has been set.

In step S735, the important element information of each influence element for the selected element is referred to as pertinent information.

If there is the pertinent information, the exclusion unit 132 sets the check flag of “necessary” in the pertinent information.

If there is not the pertinent information, the exclusion unit 132 generates important element information where a component ID that is the same as the pertinent ID has been set, and then adds the generated important element information to the important element file 204. Then, the exclusion unit 132 sets the check flag of “necessary” in the added important element information.

In step S736, the exclusion unit 132 determines whether there is the important element information that has not been selected.

In step S736, the important element information that has not been selected is referred to as non-selected information.

If there is the non-selected information, the procedure proceeds to step S731.

If there is not the non-selected information, the procedure proceeds to step S737.

In step S737, the exclusion unit 132 selects, from the important element file 204, one or more pieces of the important element information where the check flags are blank.

In step S737, each piece of the important element information where the check flag is blank is referred to as exclusion information.

The exclusion unit 132 sets the check flag of “unnecessary” in each piece of the exclusion information.

The description will be continued from step S740 by returning to FIG. 36.

In step S740, a visualization unit 140 generates a visualization diagram 205, based on the important element file 204 and the software structure file 202.

Step S740 is the same as step S130 in the first embodiment (see FIG. 2).

The visualization unit 140, however, emphasizes each important element which is not any exclusion element. The important element that is to be emphasized is a component corresponding to the important element information where the check flag of “necessary” has been set.

The visualization unit 140 may include each important element that is the exclusion element in the visualization diagram 205, or may not include each important element that is the exclusion element in the visualization diagram 205.

If each important element that is the exclusion element is included in the visualization diagram 205, the visualization unit 140 describes each important element that is the exclusion element by using a representation indicating that each important element is the component for which checking is not necessary. That is, the visualization unit 140 describes each important element that is the exclusion element by making a distinction from each important element which is not any exclusion element.

In step S750, the visualization unit 140 causes a display to display the visualization diagram 205 by outputting data of the visualization diagram 205.

### Effect of Seventh Embodiment

The one or more components for which the checking is not necessary can be excluded from the important elements. This can confine the range of the checking.

### Supplementation of Embodiments

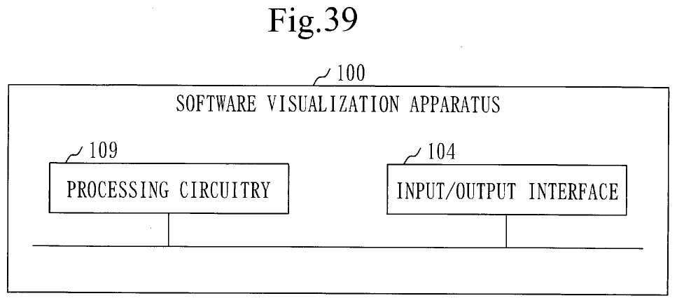

A hardware configuration of the software visualization apparatus 100 will be described based on FIG. 39.

The software visualization apparatus 100 includes a processing circuitry 109.

The processing circuitry 109 is hardware to implement the reception unit 110, the association unit 120, the determination unit 130, the calculation unit 131, the exclusion unit 132, the visualization unit 140, and the output unit 150.

The processing circuitry 109 may be dedicated hardware or the processor 101 to execute the program that is stored in the memory 102.

When the processing circuitry 109 is the dedicated hardware, the processing circuitry 109 is a single circuit, a composite circuit, a programmed processor, a parallel-programmed processor, an ASIC, an FPGA, or a combination of these pieces of the hardware.

ASIC is an abbreviation for Application Specific Integrated Circuit, and FPGA is an abbreviation for Field Programmable Gate Array.

The software visualization apparatus 100 may include a plurality of processing circuits that substitute the processing circuitry 109. The plurality of processing circuits share the roles of the processing circuitry 109.

A part of functions of the processing circuitry 109 may be implemented by the dedicated hardware, and the remainder of the functions may be implemented by software or hardware.

As mentioned above, the processing circuitry 109 can be implemented by the hardware, the software, firmware, or a combination of these pieces of the hardware, the software, and the firmware.

Each embodiment is an illustration of a desired mode and does not intend to limit the technical range of the present invention. Each embodiment may be partially carried out or may be carried out by combination with a different embodiment. Each procedure that has been described by using the flowchart and so on may be suitably modified.

Specifically, the second to seventh embodiments may be combined to be carried out. To take an example, each important element may be emphasized according to the sum of the number of executions and the evaluation index. Each important element, each influence element, and each changed element may be emphasized in a state where a distinction has been mutually made among the important element, the influence element, and the changed element. A component for which checking is not necessary may be excluded from the important element.

A method of emphasizing each important element, each influence element, or each changed element is not limited to the one using a color or a size. To take an example, each important element or the like may be emphasized by changing the shape or adding a mark.

A combination of information constituting the execution element information, the component information, the association information or the important element information is not limited to the combination of the information given in each embodiment. A part of the information may be deleted from the combination of the information given in each embodiment. Other information may be added to the combination of the information given in each embodiment.

### REFERENCE SIGNS LIST

100: software visualization apparatus; 101: processor; 102: memory; 103: auxiliary storage device; 104: input/output device; 109: processing circuitry; 110: reception unit; 120: association unit; 130: determination unit; 131: calculation unit; 132: exclusion unit; 140: visualization unit; 150: output unit; 191: storage unit; 201: execution history file; 202: software structure file; 203: association file; 204: important element file; 205: visualization diagram; 210: call graph; 211: file frame; 212: class frame; 213: function figure; 214: call line; 220: flowchart

1-9. (canceled)

10. A software visualization apparatus comprising:
processing circuitry
to receive execution history information including execution element information for each execution element that is a component which has been executed among a plurality of components that are included in a target program and software structure information including component information for each component as information indicating a structure of the target program,
to associate each piece of execution element information included in the execution history information and each piece of component information included in the software structure information with each other, thereby generating association information,
to determine each execution element and a parent element of each execution element as important elements by referring to the software structure information based on the association information and generate important element information indicating each important element, and
to generate a visualization diagram indicating the structure of the target program in a state where each important element has been emphasized, based on the important element information and the software structure information.

11. The software visualization apparatus according to claim 10,
wherein the processing circuitry
calculates a number of times of execution of each important element as a degree of importance, based on the execution history information, and
emphasizes each important element according to the degree of importance, thereby generating the visualization diagram.

12. The software visualization apparatus according to claim 10,
wherein the processing circuitry
calculates, as a degree of importance, an evaluation index that is obtained by evaluating each important element, based on the software structure information, and
emphasizes each important element according to the degree of importance, thereby generating the visualization diagram.

13. The software visualization apparatus according to claim 10,
wherein the processing circuitry
determines an influence element that will be influenced from each important element, based on the software structure information, and
emphasizes the influence element in a state where a distinction has been made from each important element, thereby generating the visualization diagram.

14. The software visualization apparatus according to claim 10,
wherein the software structure information includes a plurality of pieces of the component information of the target program and a plurality of pieces of component information of a reference program whose version is different from a version of the target program, and
wherein the processing circuitry
determines, among the plurality of components of the target program, a changed element that is different from any component of the reference program, based on the software structure information, and
emphasizes the changed element in a state where a distinction has been made from each important element, thereby generating the virtualization diagram.

15. The software visualization apparatus according to claim 10,
wherein the software structure information includes a plurality of pieces of the component information of the target program and a plurality of pieces of component information of a reference program whose version is different from a version of the target program, and
wherein the processing circuitry
determines, among the plurality of components of the target program, a changed element that is different from any component of the reference program, based on the software structure information,
determines, as an exclusion element, the important element that is neither the changed element nor an influence element that will be influenced from the changed element, based on the software structure information, and
emphasizes each important element which is not any exclusion element, thereby generating the visualization diagram.

16. The software visualization apparatus according to claim 10,
wherein the processing circuitry selects, from a plurality of pieces of execution history information that are obtained by executing the target program a plurality of times, two or more pieces of execution history information and associates each piece of the execution element information included in the selected two or more pieces of execution history information and each piece of the component information included in the software structure information with each other, thereby generating the association information.

17. The software visualization apparatus according to claim 10,
wherein the execution history information is an execution history file,
wherein the software structure information is a software structure file,
wherein the association information is an association file, and
wherein the important element information is an important element file.

18. A software visualization method comprising:
receiving execution history information including execution element information for each execution element that is a component which has been executed among a plurality of components that are included in a target program and software structure information including component information for each component as information indicating a structure of the target program;
associating each piece of execution element information included in the execution history information and each piece of component information included in the software structure information with each other, thereby generating association information;
determining each execution element and a parent element of each execution element as important elements by referring to the software structure information based on the association information and generating important element information indicating each important element; and
generating a visualization diagram indicating the structure of the target program in a state where each important element has been emphasized, based on the important element information and the software structure information.

19. The software visualization method according to claim 18,
wherein the execution history information is an execution history file,
wherein the software structure information is a software structure file,
wherein the association information is an association file, and
wherein the important element information is an important element file.

20. A non-transitory computer readable medium storing a software visualization program for causing a computer to execute:
a reception process of receiving execution history information including execution element information for each execution element that is a component which has been executed among a plurality of components that are included in a target program and software structure information including component information for each component as information indicating a structure of the target program;
an association process of associating each piece of execution element information included in the execution history information and each piece of component information included in the software structure information with each other, thereby generating association information;
a determination process of determining each execution element and a parent element of each execution element as important elements by referring to the software structure information based on the association information and generating important element information indicating each important element; and
a visualization process of generating a visualization diagram indicating the structure of the target program in a state where each important element has been emphasized, based on the important element information and the software structure information.

21. The software visualization program according to claim 20,
wherein the execution history information is an execution history file,
wherein the software structure information is a software structure file,
wherein the association information is an association file, and
wherein the important element information is an important element file.
